(19) United States
(12) Patent Application Publication
(10) Pub. No.: US 2006/0034731 A1
(43) Pub. Date: Feb. 16, 2006

(54) Sensor arrays for detecting analytes in fluids

(75) Inventors: Nathan S. Lewis, La Canada, CA (US); Ting Gao, Sunnyvale, CA (US)

Correspondence Address: BUCHANAN INGERSOLL LLP;(INCLUDING BURNS, DOANE, SWECKER & MATHIS), 12230 EL CAMINO REAL, SUITE 300, SAN DIEGO, CA, 92130, US

(73) Assignee: California Institute of Technology, Pasadena, CA (US)

(21) Appl. No.: 11/157,316

(22) Filed: Jun. 20, 2005

Related U.S. Application Data
(63) Continuation-in-part of application No. 10/409,449, filed on Apr. 7, 2003.
Application No. 10/409,449 is a continuation of application No. 09/369,507, filed on Aug. 6, 1999, now abandoned.
Application No. 09/369,507 is a continuation of application No. 09/209,914, filed on Dec. 11, 1998, now Pat. No. 6,017,440.
Application No. 09/209,914 is a continuation of application No. 08/986,500, filed on Dec. 8, 1997, now Pat. No. 6,010,616.
Application No. 08/986,500 is a continuation of application No. 08/689,227, filed on Aug. 7, 1996, now Pat. No. 5,698,089.
Application No. 08/689,227 is a continuation of application No. 08/410,809, filed on Mar. 27, 1995, now Pat. No. 5,571,401.
(60) Provisional application No. 60/664,922, filed on Mar. 23, 2005.

(51) Int. Cl. G01N 27/00

(52) U.S. Cl. 422/88; 422/98

(57) ABSTRACT

The disclosure provides methods, apparatuses and expert systems for detecting analytes in fluids. The apparatuses include a chemical sensor comprising first and second conductive elements (e.g. electrical leads) electrically coupled to and separated by a sensing area comprising a chemically sensitive resistor which provides an electrical path between the conductive elements.

### CROSS REFERENCE TO RELATED APPLICATIONS

This is a continuation-in-part of U.S. application Ser. No. 10/409,449, filed Apr. 7, 2003, still pending, which is a continuation of U.S. application Ser. No. 09/369,507, filed Aug. 6, 1999, now abandoned, which is a continuation of U.S. application Ser. No. 09/209,914, filed Dec. 11, 1998, now U.S. Pat. No. 6,017,440, which is a continuation of U.S. application Ser. No. 08/986,500, filed Dec. 8, 1997, now U.S. Pat. No. 6,010,616, which is a continuation of U.S. application Ser. No. 08/689,227, filed on Aug. 7, 1996, now U.S. Pat. No. 5,698,089, which is a continuation of U.S. application Ser. No. 08/410,809, filed on Mar. 27, 1995, now U.S. Pat. No. 5,571,401. This application also claims priority under 35 U.S.C. §119 to U.S. Provisional Application No. 60/664,922, filed Mar. 23, 2005, entitled, “Array-Based Vapor Sensing Using Chemically Sensitive, Carbon Black-Small Organic Molecules Resistors.” All of the above patents and applications are expressly incorporated herein by reference.

### STATEMENT REGARDING FEDERALLY SPONSORED RESEARCH

This invention was funded in part by a grant from the National Science Foundation (CHE 9202583). The government may have certain rights in the invention.

### TECHNICAL FIELD

The field of the disclosure is electrical sensors for detecting analytes in fluids.

### BACKGROUND

There is considerable interest in developing sensors that act as analogs of the mammalian olfactory system (1-2). This system is thought to utilize probabilistic repertoires of many different receptors to recognize a single odorant (3-4). In such a configuration, the burden of recognition is not on highly specific receptors, as in the traditional “lock-and-key” molecular recognition approach to chemical sensing, but lies instead on the distributed pattern processing of the olfactory bulb and the brain (5-6).

Prior attempts to produce a broadly responsive senor array have exploited heated metal oxide thin film resistors (7-9), polymer sorption layers on the surfaces of acoustic wave resonators (10-11), arrays of electrochemical detectors (12-14), or conductive polymers (15-16). Arrays of metal oxide thin film resistors, typically based on SnO₂ films that have been coated with various catalysts, yield distinct, diagnostic responses for several vapors (7-9). However, due to the lack of understanding of catalyst function, SnO₂ arrays do not allow deliberate chemical control of the response of elements in the arrays nor reproducibility of response from array to array. Surface acoustic wave resonators are extremely sensitive to both mass and acoustic impedance changes of the coatings in array elements, but the signal transduction mechanism involves somewhat complicated electronics, requiring frequency measurement to 1 Hz while sustaining a 100 MHz Rayleigh wave in the crystal (10-11). Attempts have been made to construct sensors with conducting polymer elements that have been grown electrochemically through nominally identical polymer films and coatings (15-18).

It is an object herein to provide a broadly responsive analyte detection sensor array based on a variety of “chemiresistor” elements. Such elements are simply prepared and are readily modified chemically to respond to a broad range of analytes. In addition, these sensors yield a rapid, low power, dc electrical signal in response to the fluid of interest, and their signals are readily integrated with software or hardware-based neural networks for purposes of analyte identification.

### RELEVANT LITERATURE

Pearce et al. (1993) Analyst 118, 371-377 and Gardner et al. (1994) Sensors and Actuators B, 18-19, 240-243 describe polypyrrole-based sensor arrays for monitoring beer flavor. Shurmer (1990) U.S. Pat. No. 4,907,441 describes general sensor arrays with particular electrical circuitry.

The disclosure provides methods, apparatuses and expert systems for detecting analytes in fluids. The apparatuses include a chemical sensor comprising first and second conductive elements (e.g. electrical leads) electrically coupled to and separated by a sensing area, which provides an electrical path between the conductive elements. The sensing area comprises a plurality of non-conductive regions (e.g., comprising a non-conductive material) and conductive regions (e.g., comprising a conductive material) between the conductive leads. The electrical path between the first and second conductive elements is transverse to (i.e. passes through) the plurality of non-conductive and conductive regions. In use, the resistor provides a change in resistance between the conductive leads when contacted with an analyte that adsorbs, absorbs, or interacts with the sensing area. For example, a difference in resistance between the conductive elements occurs when the sensing area is contacted with a fluid comprising a chemical analyte.

Variability in chemical sensitivity from sensor to sensor is conveniently provided by qualitatively or quantitatively varying the composition of the conductive and/or non-conductive regions. For example, in one embodiment, the conductive material in each resistor is held constant (e.g. the same conductive material such as polypyrrole) while the non-conductive material varies between resistors. Alternatively, the non-conductive materials are held constant and the conducting material varied. Furthermore, variability can be generated by varying the thickness of a sensor material compared to another sensor of the same material.

Arrays of such sensors are constructed with at least two sensors having different chemically sensitive resistors providing differences in resistance. An electronic nose for detecting an analyte in a fluid may be constructed by using such arrays in conjunction with an electrical measuring device electrically connected to the conductive elements of each sensor. Such electronic noses may incorporate a variety of additional components including means for monitoring the temporal response of each sensor, assembling and analyzing sensor data to determine analyte identity, and the like. Methods of making and using the disclosed sensors, arrays and electronic noses are also provided.

The invention provides a sensor for detecting an analyte in a fluid. The sensor comprises a sensing area having regions of a non-conductive material and a conductive material, wherein the non-conductive material is selected from the group consisting of an inorganic material, a non-organic material, a non-polymeric organic material, a conductive material or non-conductive material capped with a non-conductive material, and combinations thereof, wherein the sensing area provides an electrical path through said regions of non-conductive material and conductive material and wherein the sensing area is in contact with an analyte to be detected. In one aspect, the conductive material is an inorganic conductor or a conductive polymeric material. In one aspect, the conductive material is an inorganic conductor or a conductive polymeric material. In another aspect, the conductive material is a conductive polymer and the non-conductive material is an inorganic material. In yet another aspect, the inorganic non-conductive material is any inorganic non-conductive material available in the art. For example, the inorganic material can be selected from the group consisting of BeO, a ceramic, a glass, a mica, LiF, Li₂O, A₂O₃, BaF₂, CaF₂, MgF₂, silicon carbide, Al—Mg, a boron-doped oxide (BSO), a phosphorus-doped oxide (PSO), a boron and phosphorus-doped oxide (BPSO), and a fluorine-doped oxide (FSO). For example, the ceramic can be alumina (Al₂O₃), silica (SiO₂), zirconia (ZrO), magnesia, mullite, cordierite, aluminum silicate, forsterite, petalite, eucryptite and quartz glass, SiOₓ, SiN, SiNₓ, SiON, TEOS, Si₃N₄ or a combination thereof, with or without capped non-conductive materials (e.g., capped with an alkylthiol). The inorganic non-conductive material can be a mixed inorganic/organic material comprising, for example, an insulating capped colloid particle (e.g., an alkylthiol-capped gold particle or a capped TiO₂ colloid). The underlying capped particle can be a conductive or non-conductive material. In another aspect, the non-conductive material is a non-polymeric material (e.g., tris (hydroxymethyl) nitromethane, tetrapctulammonium bromide, lauric acid, tetrocosane acid, 3-methyl-2-pherylvaleric acid, eicosane, tetracosane, triactane, propyl gallate, 1,2,5,6,9,10-hexabromocyclododecane, quinacrine dihydrochloride dihydrate, dioctyl phthalate, or any combination thereof). In any aspect of the invention, the non-conductive material (e.g., the inorganic or organic non-conductive material) may include caps of a non-conductive material. The non-polymeric non-conductive material can be a capped non-polymeric material, wherein the cap comprises an non-conductive material linked covalently or non-covalently to the underlying non-polymeric non-conductive material.

The invention also provides a sensor array for detecting an analyte in a fluid. The sensor array comprises at least first and second chemically sensitive resistors electrically connected to an electrical measuring apparatus, each of said chemically sensitive resistors comprising regions of a non-conductive material and a conductive material, wherein the non-conductive material is an inorganic non-conductive material or a non-polymeric non-conductive material (as described above), wherein each resistor provides an electrical path through said regions of non-conductive material and conductive material.

The invention also provides a system for detecting an analyte in a fluid. The system includes a sensor array comprising at least first and second chemically sensitive resistors, each chemically sensitive resistor comprising regions of non-conductive material and conductive material, each resistor providing an electrical path through the regions of non-conductive material and the conductive material; an electrical measuring device electrically connected to the sensor array; and a computer comprising a resident algorithm; the electrical measuring device detecting an electrical resistance in each of said chemically sensitive resistors and the computer assembling the resistances into a sensor array response profile. In one aspect, the non-conductive material of the first chemically sensitive resistor is different from the non-conductive material of the second chemically sensitive resistor. In one aspect, the conductive material is an inorganic conductor or a conductive polymeric material. In another aspect, the conductive material is a conductive polymer and the non-conductive material is an inorganic material. In yet another aspect, the inorganic non-conductive material is any inorganic non-conductive material available in the art. For example, the inorganic material can be selected from the group consisting of BeO, a ceramic, a glass, a mica, LiF, Li₂O, A₂O₃, BaF₂, CaF₂, MgF₂, silicon carbide, Al—Mg, a boron-doped oxide (BSO), a phosphorus-doped oxide (PSO), a boron and phosphorus-doped oxide (BPSO), and a fluorine-doped oxide (FSO). For example, the ceramic can be alumina (Al₂O₃), silica (SiO₂), zirconia (ZrO), magnesia, mullite, cordierite, aluminum silicate, forsterite, petalite, eucryptite and quartz glass, SiOₓ, SiN, SiNₓ, SiON, TEOS, Si₃N₄ or a combination thereof, with or without capped non-conductive materials (e.g., capped with an alkylthiol). The inorganic non-conductive material can be a mixed inorganic/organic material comprising, for example, an insulating capped colloid particle (e.g., an alkylthiol-capped gold particle or a capped TiO₂ colloid). The underlying capped particle can be a conductive or non-conductive material. In another aspect, the non-conductive material is a non-polymeric material (e.g., tris (hydroxymethyl) nitromethane, tetrapctulammonium bromide, lauric acid, tetrocosane acid, 3-methyl-2-pherylvaleric acid, eicosane, tetracosane, triactane, propyl gallate, 1,2,5,6,9,10-hexabromocyclododecane, quinacrine dihydrochloride dihydrate, dioctyl phthalate, or any combination thereof). In any aspect of the invention, the non-conductive material (e.g., the inorganic or organic non-conductive material) may include caps of a non-conductive material. The non-polymeric non-conductive material can be a capped non-polymeric material, wherein the cap comprises an non-conductive material linked covalently or non-covalently to the underlying non-polymeric non-conductive material.

The invention also provides a method for detecting the presence of an analyte in a fluid. The method includes resistively sensing the presence of an analyte in a fluid with a sensor or a sensor array comprising a chemically sensitive resistor having regions of a non-conductive material and a conductive material, wherein the non-conductive material is an inorganic material, a non-organic material, a non-polymeric material or a combination thereof. In one aspect, the conductive material is an inorganic conductor or a conductive polymeric material. In another aspect, the conductive material is a conductive polymer and the non-conductive material is an inorganic material. In yet another aspect, the inorganic non-conductive material is any inorganic non-conductive material available in the art. For example, the inorganic material can be selected from the group consisting of BeO, a ceramic, a glass, a mica, LiF, Li₂O, A₂O₃, BaF₂, CaF₂, MgF₂, silicon carbide, Al—Mg, a boron-doped oxide (BSO), a phosphorus-doped oxide (PSO), a boron and phosphorus-doped oxide (BPSO), and a fluorine-doped oxide (FSO). For example, the ceramic can be alumina (Al₂O₃), silica (SiO₂), zirconia (ZrO), magnesia, mullite, cordierite, aluminum silicate, forsterite, petalite, eucryptite and quartz glass, SiOₓ, SiN, SiNₓ, SiON, TEOS, Si₃N₄ or a combination thereof, with or without capped non-conductive materials (e.g., capped with an alkylthiol). The inorganic non-conductive material can be a mixed inorganic/organic material comprising, for example, an insulating capped colloid particle (e.g., an alkylthiol-capped gold particle or a capped TiO₂ colloid). The underlying capped particle can be a conductive or non-conductive material. In another aspect, the non-conductive material is a non-polymeric material (e.g., tris (hydroxymethyl) nitromethane, tetrapctulammonium bromide, lauric acid, tetrocosane acid, 3-methyl-2-pherylvaleric acid, eicosane, tetracosane, triactane, propyl gallate, 1,2,5,6,9,10-hexabromocyclododecane, quinacrine dihydrochloride dihydrate, dioctyl phthalate, or any combination thereof). In any aspect of the invention, the non-conductive material (e.g., the inorganic or organic non-conductive material) may include caps of a non-conductive material. The non-polymeric non-conductive material can be a capped non-polymeric material, wherein the cap comprises an non-conductive material linked covalently or non-covalently to the underlying non-polymeric non-conductive material.

The invention includes a method of manufacturing a chemically sensitive sensor of the invention. The method comprises providing (1) a non-conductive material and a conductive material, wherein the non-conductive material is selected from the group consisting of an inorganic non-conductive material, a non-organic non-conductive material, a non-polymeric non-conductive material, and a combination thereof, (2) a solvent, (3) at least two conductive leads and (4) a substrate; mixing the non-conductive material, the conductive material and the solvent to form a mixture; contacting the substrate with the mixture such that the mixture is contacted with the substrate between the at least two conductive leads; and allowing the solvent to substantially evaporate leaving a sensor film between the two conductive leads. The mixing of the components may be performed by mechanical mixing (e.g., ball-milling) and may include heating. In some aspects, one of the conductive or non-conductive materials is dissolved in the solvent. In another aspect, one material is dissolved in the solvent and the other is suspended in the solvent. In another aspect, the mixture is applied to a substrate by spin coating, spray coating and/or dip coating. In yet another aspect, the sensor film is removed from the substrate. The mixture may further comprise an additive that increases the sensor rigidity.

The invention also provides a method of manufacturing a chemically sensitive sensor, comprising providing (1) a solution of a non-conductive material dissolved in a solvent, providing a solution of a conductive material dissolved in a solvent, wherein the non-conductive material is a inorganic non-conductive material, a non-organic non-conductive material, or a non-polymeric non-conductive material; and coating each solution at locations on a substrate and conducting at least two conductive leads such that the coated material provides an electrical path between the conductive leads. In one aspect, the solutions are delivered by an inkjet device. In another aspect, the ejecting of the solution from the inkjet device is directed to pre-selected regions of the substrate.

The invention also provides a method of manufacturing a chemically sensitive sensor, comprising providing (1) a solution of a non-conductive material and a conductive material dissolved in a solvent, wherein the non-conductive material is a inorganic non-conductive material, a non-organic non-conductive material, or a non-polymeric non-conductive material; delivering the solution to an inkjet device; ejecting the solution from the inkjet device onto the pre-selected region of the substrate; and connecting at least two conductive leads to the pre-selected region of the substrate.

The invention also provides a sensor for detecting an analyte in a fluid. The sensor comprises a sensing area having regions of non-conductive material and a conductive material arranged between two conductive leads, wherein the non-conductive material is an inorganic material, a non-organic material and/or a non-polymeric material, wherein during use, the permeation of the sensing area by the analyte produces a resistance which is different from a baseline resistance. In one aspect, the conductive material is an inorganic conductor or a conductive polymeric material. In another aspect, the conductive material is a conductive polymer and the non-conductive material is an inorganic material. In yet another aspect, the inorganic non-conductive material is any inorganic non-conductive material available in the art. For example, the inorganic material can be selected from the group consisting of BeO, a ceramic, a glass, a mica, LiF, Li₂O, A₂O₃, BaF₂, CaF₂, MgF₂, silicon carbide, Al—Mg, a boron-doped oxide (BSO), a phosphorus-doped oxide (PSO), a boron and phosphorus-doped oxide (BPSO), and a fluorine-doped oxide (FSO). For example, the ceramic can be alumina (Al₂O₃), silica (SiO₂), zirconia (ZrO), magnesia, mullite, cordierite, aluminum silicate, forsterite, petalite, eucryptite and quartz glass, SiOₓ, SiN, SiNₓ, SiON, TEOS, Si₃N₄ or a combination thereof, with or without capped non-conductive materials (e.g., capped with an alkylthiol). The inorganic non-conductive material can be a mixed inorganic/organic material comprising, for example, an insulating capped colloid particle (e.g., an alkylthiol-capped gold particle or a capped TiO₂ colloid). The underlying capped particle can be a conductive or non-conductive material. In another aspect, the non-conductive material is a non-polymeric material (e.g., tris (hydroxymethyl) nitromethane, tetrapctulammonium bromide, lauric acid, tetrocosane acid, 3-methyl-2-pherylvaleric acid, eicosane, tetracosane, triactane, propyl gallate, 1,2,5,6,9,10-hexabromocyclododecane, quinacrine dihydrochloride dihydrate, dioctyl phthalate, or any combination thereof). In any aspect of the invention, the non-conductive material (e.g., the inorganic or organic non-conductive material) may include caps of a non-conductive material. The non-polymeric non-conductive material can be a capped non-polymeric material, wherein the cap comprises an non-conductive material linked covalently or non-covalently to the underlying non-polymeric non-conductive material. Additional examples of conductive material that can be used in the sensor include a mixed inorganic/organic conductor (e.g., tetracyanoplatinate complexes, iridium halocarbonyl complexes, and stacked macrocyclic complexes), a doped semiconductor (e.g., Si, GaAs, InP, MoS₂, and TiO₂), a conductive metal oxide (e.g., In₂ O₃, SnO₂, and Naₓ Pt₃ O₄), and/or a superconductor (e.g., YBa₂ Cu₃ O₇, Ti₂ Ba₂ Ca₂ Cu₃ O₁₀).

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1(A) shows an overview of sensor design.

FIG. 1(B) shows an overview of sensor operation.

FIG. 1(C) shows an overview of system operation.

FIG. 2 shows a cyclic voltammogram of a poly(pyrrole) coated platinum electrode. The electrolyte was 0.10 M [(C₄H₉)₄N]⁺[ClO₄]⁻ in acetonitrile, with a scan rate of 0.10 V s⁻¹.

FIG. 3(A) shows the optical spectrum of a spin coated poly(pyrrole) film that had been washed with methanol to remove excess pyrrole and reduced phosphomolybdic acid.

FIG. 3(B) shows the optical spectrum of a spin-coated poly(pyrrole) film on indium-tin-oxide after 10 potential cycles between +0.70 and −1.00 V vs. SCE in 0.10 M [(C₄H₉)₄N]⁺[ClO₄]³¹ in acetonitrile at a scan rate of 0.10 V-s⁻¹. The spectra were obtained in 0.10 M KCl—H₂O.

FIG. 4(A-C); FIG. 4A shows a schematic of a sensor array showing an enlargement of one of the modified ceramic capacitors used as sensing elements. The response patterns generated by the sensor array described in Table 5 are displayed for: FIG. 4(B) acetone; FIG. 4(C) benzene; and FIG. 4(D) ethanol.

FIG. 5(A-D) shows a principal component analysis of autoscaled data from individual sensors containing different non-conductive polymers: (A) poly(styrene); (B) poly (α-methyl styrene); (C) poly(styrene-acrylonitrile); (D) poly(styrene-allyl alcohol).

FIGS. 6(A-B) show a principal component analysis of data obtained from all sensors (Table 5). Conditions and symbols are identical to FIGS. 5(A-D). FIG. 6A shows data represented in the first three principal components pc1, pc2 and pc3, while FIG. 6B shows the data when represented in pc1, pc2, and pc4. A higher degree of discrimination between some solvents could be obtained by considering the fourth principal component as illustrated by larger separations between chloroform, tetrahydrofuran, and isopropyl alcohol in FIG. 6B.

FIG. 7(A) shows a plot of acetone partial pressure (∘) as a function of the first principal component; linear least square fit (--) between the partial pressure of acetone and the first principal component (Pₐ=8.26·pc1+83.4, R²=0.989); acetone partial pressure (+) predicted from a multi-linear least square fit between the partial pressure of acetone and the first three principal components (P^{a}=8.26·pc1−0.673·pc2+6.25·pc3+83.4, R²=0.998).

FIG. 7(B) shows a plot of the mole fraction of methanol, xₘ, (∘) in a methanol-ethanol mixture as a function of the first principal component; linear least square fit (---) between xₘ and the first principal component (xₘ=0.112·pc1+0.524, R²=0.979); xₘ predicted from a multi-linear least square fit (+) between xₘ and the first three principal components (xₘ=0.112·pc1−0.0300·pc2−0.0444·pc3+0.524, R²=0.987).

FIG. 8. The resistance response of a poly(N-vinylpyrrolidone):carbon black (20 w/w % carbon black) sensor element to methanol, acetone, and benzene. The analyte was introduced at t=60 s for 60 s. Each trace is normalized by the resistance of the sensor element (approx. 125 Ω) before each exposure.

FIG. 9 shows the first three principal components for the response of a carbon-black based sensor array with 10 elements. The non-conductive components of the carbon-black composites used are listed in Table 5, and the resistors were 20 w/w % carbon black.

FIG. 10(A-C) shows transmission electron micrograph of (A) hexylthiol capped gold nanocrystals (Au—S—C₆), (B) hexadecylmercaptane capped gold nanocrystals (Au—S—C₁₆) and (C) 4methoxy-α-toluenethiol capped gold nanocrystals (Au—S—CPhOC), respectively.

FIGS. 11(A-B) show the sensor responses using capped Au colloids as sensors. (A) Sensor response, ΔR/R_{b}, to n-hexane at 0.005 P/P^{o} in clean lab air for a sensor made from alkanethiol-capped gold nanoparticles mixed with carbon black, and for three carbon black-polymer composite sensors. Here, C3/CB represents Au—S—C₃/carbon black sensors, and so on. (B) Sensor response, ΔR/R_{b}, to ethanol at 0.005 P/P^{o} in clean lab air for alkanethiol capped gold nanoparticles mixed with carbon black and for three carbon black-polymer composite sensors. Here, C3/CB represents Au—S—C₃/carbon black sensors, and so on.

FIGS. 12(A-D) show sensor responses. (A) shows a two-dimensional bar graph of sensor response, ΔR/R_{b} for the eight thiol capped gold nanoparticle sensors to hexane, THF and ethanol, (B) is a three-dimensional bar graph of sensor responses ΔR/R_{b} for the eight thiol capped gold nanoparticle sensors to the eight analytes hexane, THF, ethanol, ethyl acetate, cyclohexane, heptane, octane and iso-octane. All analytes were tested at P/P^{o}=0.005. (C-D) show sensor response for Au—S—C2Ph, Au—S—C16, Au—S—CPhOC, Au—S—C60H, Au—S—C6, PEVA and PEO as a function of concentration of (C) n-hexane and (D) ethanol. For clarity the dose responses of Au—S—C3, Au—S—C8 and Au—S—C12 were not plotted in this figure as these had similar response to that of Au—S—C2Ph.

FIG. 13 shows the sensor resistance response of TiO₂—C₁₆-carbon black sensors to eight tested analytes, n-hexane, ethanol, THF, ethyl acetate, cyclohexane, heptane, octane, iso-octane at 0.005 P/P^{o} in clean lab air.

FIGS. 14(A-B) show the resistance responses of a sensor comprising non-polymeric non-conductive materials. (A) Shows the resistance response of carbon black-eicosane and (B) of carbon black-eicosane/dioctyl phthalate sensors (62.5:37.5) upon exposure to n-hexane at 0.074 P/P^{o} in air.

FIG. 15 shows sensor resistance response of an Au—S—C₂Ph/10% carbon black sensor upon eleven cycles of hexane exposures at 0.005 P/P^{o} in air. The 11 cycles were extracted sequentially from the 1600 exposures of randomly sampled eight analytes.

FIG. 16 shows the 3-D pattern of six capped TiO₂-type colloids-carbon black sensors to seven analytes tested at a concentration of 0.005 P/P^{o}. Here, C₈, C₁₂, C₁₆, C₂₄ C₁₂Br and C₄C═CC₆ represent TiO₂—C₈/carbon black, TiO₂—Cl₂/carbon black, TiO₂—Cl₆/carbon black, TiO₂—C₂₄/carbon black, TiO₂—Cl₂Br/carbon black, TiO₂—C₄C═CC₆/carbon black, respectively.

FIG. 17(A-B) show plots of the resistance change of (A) quinacrine dihydrochloride dihydrate (sensor 8, table 10a) to ethanol and (B) polycaprolactone (sensor 1, table 10b) to c-hexane each at P/P^{o}=0.0050. The sensors and analytes were chosen because they both exhibit approximately the same SNR.

FIG. 18 shows a plot of sensor response, ΔR/R_{b}, of carbon black composites of tetracosane/dioctyl phthalate (sensor 5, table 10a) to nine hexane exposures at a concentration of P/P^{o}=0.005 in air. Each cycle consisted of 70 s of air, 80 s of vapor, and then 60 s of air. Numerous exposures to different analytes occurred between each shown exposure to hexane.

FIG. 19(A-B) shows a plot of several sensor responses, ΔR/R_{b}, to (A) n-hexane and (B) ethanol at various concentrations.

FIG. 20 shows a 3-D pattern detailing the mean carbon black-non polymer sensor (table 10a for descriptions) responses to the 7 test analytes at concentration of P/P^{o}=0.005 in air. Standard deviations of sensor responses are given in table 11a.

FIG. 21 shows a principal component analysis detailing the response of the sensor array to the seven test analytes. The two principal components displayed contained ˜90% of the variance of the sensor array response.

FIG. 22(A-B) shows “Waterfall” plots detailing drift of “D-values” vs. exposure number for the n-hexane/1-octane binary separation task. The first 100 exposures of data were used to train the model. A decision boundary (solid line) based on these first 100 exposures is shown. Results are shown for no calibration (A) and for calibration using n-octane (B).

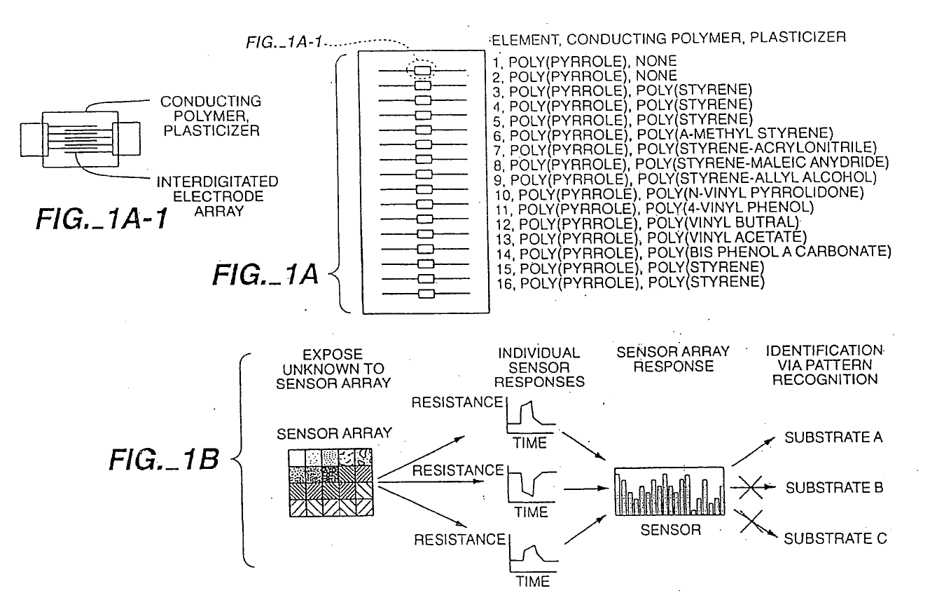

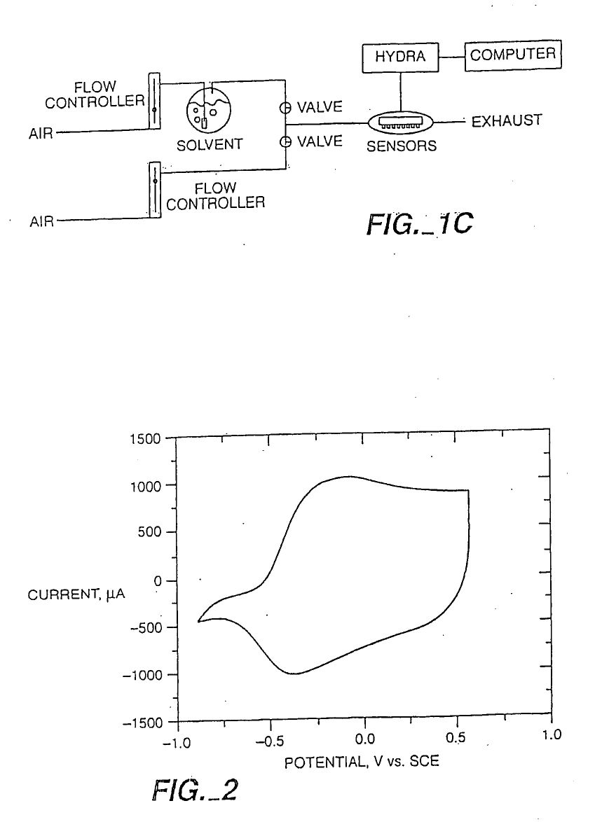

Like reference symbols in the various drawings indicate like elements.

### DETAILED DESCRIPTION

The disclosure provides sensors and sensor arrays for detecting an analyte in a fluid for use in conjunction with an electrical measuring apparatus. A sensor array comprises a plurality of chemical sensors. A sensor of the disclosure comprises at least first and second conductive leads electrically coupled to and separated by a sensing area comprising a chemically sensitive resistor. The leads may be any convenient conductive material, usually a metal, and may be interdigitized to maximize signal-to-noise strength.

The resistor comprises a plurality of non-conductive and conductive regions (e.g., alternating regions) transverse to the electrical path between the conductive leads. Generally, the resistors are comprised of conductive regions and non-conductive regions such that the electrically conductive path between the leads coupled to the resistor is interrupted by non-conductive regions. For example, in a colloid, suspension or dispersion of particulate conductive material in a matrix of non-conductive material, the matrix regions separating the particles provide the gaps. The non-conductive gaps range in path length from about 2 to 1,000 angstroms, usually on the order of 2-100 angstroms providing individual resistance of about 10 to 1,000 mΩ, usually on the order of 100 mΩ, across each gap. The path length and resistance of a given gap is not constant but rather is believed to change as the sensor absorbs, adsorbs or imbibes an analyte. Accordingly the dynamic aggregate resistance provided by these gaps in a given resistor is a function of analyte permeation of the sensing film. In some embodiments, the conductive material may contribute to the dynamic aggregate resistance as a function of analyte permeation (e.g., when the conductive material is a conductive organic polymer such as polyprryole).

A wide variety of conductive regions and non-conductive regions can be used. The conducting regions can be anything that can carry electrons from atom to atom, including, but not limited to, a material, a particle, a metal, a polymer, a substrate, an ion, an alloy, an organic material, (e.g., carbon, graphite, and the like) an inorganic material, a biomaterial, or regions thereof. Table 1 and 2 provides exemplary conductive materials for use in sensor fabrication; mixtures may also be used. In further aspects, insulators can also be added to the sensing area to further generate diversity of the sensors. Such insulating polymers include, for example, di(2-ethylhexyl)phthalate (DOP), diethylene glycol dibenzoate (DGD), glycerol triacetate (GT), tributyl phosphate (TBP), chloroparafin (50% Cl, CP), and tricresyl phosphate (TCP).

TABLE 1

| Major Class | Examples |
|---|---|
| Organic Conductors | conducting polymers (poly(anilines), |
| | poly(thiophenes), poly(pyrroles), |
| | poly(aceylenes, etc.)), carbonaceous |
| | material (carbon blacks, graphite, |
| | coke, C60 etc.), charge transfer |
| | complexes |
| | (tetramethylparaphenylenediamine- |
| | chloranile, alkali metal |
| | tetracyanoquinodimethane complexes, |
| | tetrathiofulvalene halide complexes, |
| | etc.), etc. |
| Inorganic Conductors | metals and metal alloys (Ag, Au, Cu, |
| | Pt, AuCu alloy, etc.), highly doped |
| | semiconductors (Si, GaAs, InP, MoS₂, |
| | TiO₂, etc.), conductive metal oxides |
| | (In₂O₃, SnO₂, Na₂Pt₃O₄, etc.), |
| | superconductors (Yba₂Cu₃O₇, |
| | Ti₂Ba₂Ca₂Cu₃O₁₀, etc.), etc. |
| Mixed inorganic/organic | Tetracyanoplatinate complexes, Iridium |
| Conductor | halocarbonyl complexes, stacked |
| | macrocyclic complexes, etc. |

In certain other embodiments, the conductive material is a conductive particle, such as a colloidal nanoparticle. As used herein the term “nanoparticle” refers to a conductive particle having a diameter on the nanometer scale. Such nanoparticles are optionally stabilized with organic ligands.

Examples of colloidal nanoparticles for use in accordance with the disclosure are described in the literature. In this embodiment, the central core can be either non-conductive or conductive and comprises a ligand that is attached or linked to the central core making up the nanoparticle. These ligands (i.e., caps) can be polyhomo- or polyhetero-functionalized, thereby being suitable for detecting a variety of chemical analytes. The nanoparticles, i.e., clusters, can be stabilized by the attached ligands. In certain embodiments, the conducting components of the resistors are nanoparticles comprising a central core conducting element and an attached ligand optionally in a polymer matrix. With reference to Tables 1 and 2, various conducting materials are suitable for the central core. In certain embodiments, the nanoparticles have a metal core. In other aspects, the core is made of a non-conductive material (e.g., an inorganic non-conductive material). In other embodiments, the ligand is a non-conductive material attached or linked to the metal core, wherein each metal core is in a matrix separated by non-conductive ligands. Typical metal cores include, but are not limited to, Au, Ag, Pt, Pd, Cu, Ni, AuCu and regions thereof.

Table 2 provides exemplary electrically conductive organic materials that can be used to form the organic conducting regions of the sensors. In one aspect, the conductive materials of Table 2 are used in connection with non-polymeric insulators and/or inorganic insulators.

TABLE 2

| a | 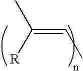 | R = alkyl, alkoxy |
|---|---|---|
| b | 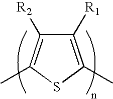 | R1 = H, alkyl, alkoxy R2 = H, alkyl, alkoxy |
| c | 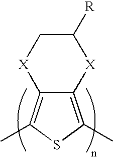 | X = S, O R = H, alkyl, alkoxy |
| d | 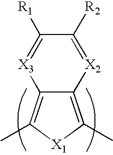 | X1 = S, O, N—H, N—R X2 = C, N X3 = C, N R1 = H, alkyl, alkoxy R2 = H, alkyl, alkoxy |
| e | 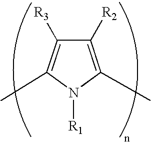 | R₁ = H, alkyl R2 = H, alkyl, alkoxy R3 = H, alkyl, alkoxy |
| f | 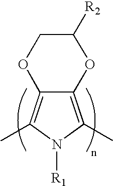 | R1 = H, alkyl R2 = H, alkyl, alkoxy |
| g | 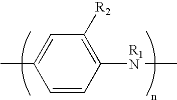 | R1 = H, alkyl, propanesulfonate R2 = H, alkyl, alkoxy, sulfonate |
| h | 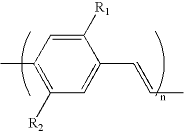 | R1 = H, alkyl, alkoxy R2 = H, alkyl, alkoxy |
| i | 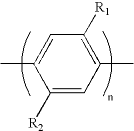 | R1 = alkyl, alkoxy R2 = alkyl, alkoxy |
| j | 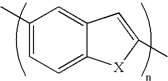 | X = S, O, N—H, N—R |
| k | 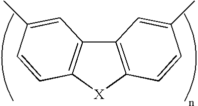 | X = S, O, N—H, N—R R = alkyl |
| l | 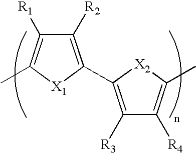 | X1 = S, O, N—H, N—R X2 = S, O, N—H, N—R R1 = H, alkyl, alkoxy R2 = H, alkyl, alkoxy R3 = H, alkyl, alkoxy R4 = H, alkyl, alkoxy R = alkyl |
| m | 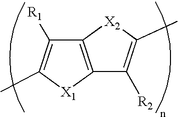 | X1 = S, O, N—H, N—R X2 = S, O, N—H, N—R |
| n | 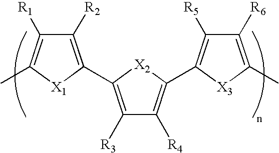 | X1 = S, O, N—H, N—R X2 = S, O, N—H, N—R X3 = S, O, N—H, N—R R = alkyl R1 = H, alkyl, alkoxy R2 = H, alkyl, alkoxy R3 = H, alkyl, alkoxy R4 = H, alkyl, alkoxy R5 = H, alkyl, alkoxy R6 = H, alkyl, alkoxy |
| o | 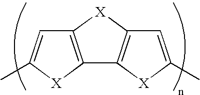 | X = S, O, N—H, N—R R = alkyl |
| p | 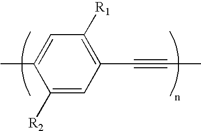 | R1 = H, alkyl, alkoxy R2 = H, alkyl, alkoxy |
| q | 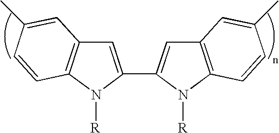 | R1 = H, alkyl |
| r | 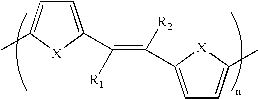 | X = S, O, N—H, N—R R1 = H, alkyl, alkoxy R2 = H, alkyl, alkoxy |
| s | 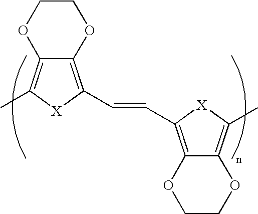 | X = S,O, N—H, N—R |
| t | 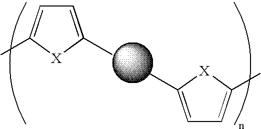 | X = S, O, N—H, N—R |
| | 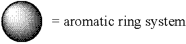 | |
| u | 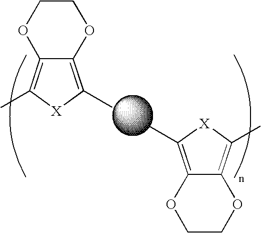 | X = S, O, N—H, N—R |
| | 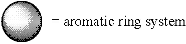 | |
| v | 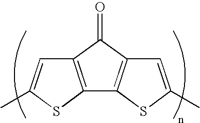 | |
| w | 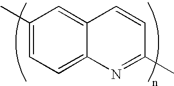 | |
| x | 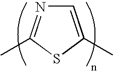 | |
| y | 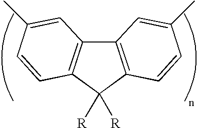 | R = H, alkyl, alkoxy |
| z | 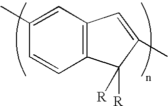 | R = H, alkyl, alkoxy |
| a. Poly(acetylene) and derivatives | | |
| b. Poly(thiophenes) and derivatives | | |
| c. Poly(3,4-ethylenedioxythiophene) and poly(3,4-ethylenedithiathiophene) and derivatives | | |
| d. Poly(isathianaphthene), poly(pyridothiophene), poly(pyrizinothiophene), and derivatives | | |
| e. Poly(pyrrole) and derivatives | | |
| f. Poly(3,4-ethylenedioxypyrrole) and derivatives | | |
| g. Poly(aniline) and derivatives | | |
| h. Poly(phenylenevinylene) and derivatives | | |
| i. Poly(p-phenylene) and derivatives | | |
| j. Poly(thianapthene), poly(benxofuran), and poly(indole) and derivatives | | |
| k. Poly(dibenzothiophene), poly(dibenxofuran), and poly(carbazole) and derivatives | | |
| l. Poly(bithiophene), poly(bifuran), poly(bipyrrole), and derivatives | | |
| m. Poly(thienothiophene), poly(thienofuran), poly(thienopyrrole), poly(furanylpyrrole), poly(furanylfuran), poly(pyrolylpyrrole), and derivatives | | |
| n. Poly(terthiophene), poly(terfuran), poly(terpyrrole), and derivatives | | |
| o. Poly(dithienothiophene), poly(difuranylthiophene), poly(dipyrrolylthiophene), poly(dithienofuran), poly(dipyrrolylfuran), poly(dipyrrolylpyrrole) and derivatives | | |
| p. Poly(phenyl acetylene) and derivatives | | |
| q. Poly(biindole) and derivatives | | |
| r. Poly(dithienovinylene), poly(difuranylvinylene), poly(dipyrrolylvinylene) and derivatives | | |
| s. Poly(1,2-trans(3,4-ethyienedioxythienyl)vinylene), poly(1,2-trans (3,4-ethylenedioxyfuranyl)vinylene), and poly(1,2-trans (3,4-ethylenedioxypyrrolyl)vinylene), and derivatives | | |
| t. The class of poly(bis-thienylarylenes) and poly(bis-pyrrolylarylenes) and derivatives | | |
| u. The class of poly(bis(3,4-ethylenedioxythienyl)arylenes) and derivatives | | |
| v. Poly(dithienylcyclopentenone) | | |
| w. Poly(quinoline) | | |
| x. Poly(thiazole) | | |
| y. Poly(fluorene) and derivatives | | |
| z. Poly(azulene) and derivatives | | |
| Notes: | | |
| a. Aromatics = phenyl, biphenyl, terphenyl, carbazole, furan, thiophene, pyrrole, fluorene, thiazole, pyridine, 2,3,5,6-hexafluorobenzene, anthracene, coronene, indole, biindole, 3,4-ethylenedioxythiophene, 3,4-ethylenedioxypyrrole, and both the alkyl and alkoxy derivatives of these aromatics. | | |
| b. Alkyl = aliphatic group branched or straight chain ranging from CH₃ to C₂₀H₄₁. | | |
| c. Alkoxy = OR, where R is an aliphatic group that may either be branched or straight chain ranging from CH₃ to C₂₀H₄₁. | | |
| d. All conductive polymers are depicted in their neutral, non-conductive form. The polymers listed in the figure are doped oxidatively either by means chemically or electrochemically. | | |
| e. The class of polyanilines are acid doped and can be done so with a number of sulfonic acids including methane sulfonic acid, ethane sulfonic acid, propane sulfonic acid, butane sulfonic acid, pentane sulfonic acid, hexane sulfonic acid, heptane sulfonic acid, octane sulfonic acid, nonane sulfonic acid, decane sulfonic acid, ondecane sulfonic acid, dodecane sulfonic acid, dodecylbenzenesulfonic acid, toluene sulfonic acid, benzene sulfonic acid, dinonanylnaphthalene sulfonic acid, and both the d and | | |
| # 1 forms of camphor sulfonic acid. | | |

f. All other class of conductive polymers when doped there is an associated counter ion to compensate the positive charges on the backbone. These can be perchlorate, hexafluorophosphate, tetrafluoroborate, fluoride, chloride, bromide, iodide, triflate, etc.

The conductive organic material can be either an organic semiconductor or organic conductor. “Semi-conductors” as used herein, include materials whose electrical conductivity increases as the temperature increases, whereas conductors are materials whose electrical conductivity decreases as the temperature increases. By this fundamental definition, the organic materials that are useful in the sensors of the disclosure are either semiconductors or conductors. Such materials are collectively referred to herein as conductive materials because they produce a readily-measured resistance between two conducting leads separated by about 10 micron or more using readily-purchased multimeters having resistance measurement limits of 100 Mohm or less, and thus allow the passage of electrical current through them when used as elements in an electronic circuit at/near room temperature. Semi-conductors and conductors can be differentiated from insulators by their different room temperature electrical conductivity values. Insulator show very low room temperature conductivity values, typically less than about 10⁻⁸ ohm⁻¹ cm⁻¹. Poly(styrene), poly(ethylene), and other polymers elaborated in Table 3 provide examples of insulating organic materials. Metals have very high room temperature conductivities, typically greater than about 10 ohm⁻¹ cm⁻¹. Semi-conductors have conductivities greater than those of insulators, and are distinguished from metals by their different temperature dependence of conductivity, as described above. Examples of semiconducting and conducting organic material are provided in Table 2. The organic materials that are useful in the sensors of the disclosure as conductive regions are either electrical semiconductors or conductors, and have room temperature electrical conductivities of greater than about 10⁻⁶ ohm⁻¹ cm⁻¹, typically having a conductivity of greater than about 10⁻³ ohm⁻¹ cm⁻¹. Other conductive materials having similar resistivity profiles are easily identified in the art (see, for example the latest edition of: The CRC Handbook of Chemistry and Physics, CRC Press, the disclosure of which is incorporated herein by reference).

The insulating region (i.e., non-conductive region) can be any material that can impede electron flow from atom to atom, including, but not limited to, a material, a polymer, a plasticizer, an organic material, an organic polymer, a non-polymeric material, a filler, a ligand, an inorganic material, a biomaterial, a solid, a liquid, a particle (e.g., capped conductive particles or capped non-conductive particles or non-capped non-conductive particles), and any combination thereof. Table 3 provides examples of insulating organic materials that can be used for such purposes. Other insulating materials are provided in Table 4.

TABLE 3

| Major Class | Examples |
|---|---|
| Main-chain carbon | poly(dienes), poly(alkenes), poly(acrylics), |
| polymers | poly(methacrylics), poly(vinyl ethers), |
| | poly(vinyl thioethers), poly(vinyl alcohols), |
| | poly(vinyl ketones), poly(vinyl halides), |
| | poly(vinyl nitrites), poly(vinyl esters), |
| | poly(styrenes), poly(aryines), etc. |
| Main-chain | poly(oxides), poly(caronates), poly(esters), |
| acyclic | poly(anhydrides), poly(urethanes), |
| heteroatom | poly(sulfonate), poly(siloxanes), poly(sulfides), |
| polymers | poly(thioesters), poly(sulfones), |
| | poly(sulfonamindes), poly(amides), poly(ureas), |
| | poly(phosphazens), poly(silanes), |
| | poly(silazanes), etc. |
| Main-chain | poly(furantetracarboxylic acid diimides), |
| heterocyclic | poly(benzoxazoles), poly(oxadiazoles), |
| polymers | poly(benzothiazinophenothiazines), |
| | poly(benzothiazoles), poly(pyrazinoquinoxalines), |
| | poly(pyromenitimides), poly(quinoxalines), |
| | poly(benzimidazoles), poly(oxidoles), |
| | poly(oxoisinodolines), poly(diaxoisoindoines), |
| | poly(triazines), poly(pyridzaines), |
| | poly(pioeraziness), poly(pyridinees), |
| | poly(pioeridiens), poly(triazoles), |
| | poly(pyrazoles), poly(pyrrolidines), |
| | poly(carboranes), poly(oxabicyclononanes), |
| | poly(diabenzofurans), poly(phthalides), |
| | poly(acetals), poly(anhydrides), carbohydrates, |
| | etc. |

TABLE 4

| | |
|---|---|
| Inorganic insulators | BeO; ceramics (e.g., alumina (Al₂O₃), |
| | silica (SiO₂), zirconia (ZrO), |
| | magnesia, mullite, cordierite, |
| | aluminum silicate, forsterite, |
| | petalite, eucryptite and quartz |
| | glass, SiOₓ, SiN, SiNₓ, SiON, |
| | TEOS, Si₃N₄); glass; mica; LiF; Li₂O; |
| | A₂O₃; BaF₂; CaF₂; MgF₂; silicon |
| | carbide; Al-Mg; boron-doped oxide |
| | (BSG); phosphorus-doped oxide (PSG); |
| | boron and phosphorus-doped oxide |
| | (BPSG); Fluorine-doped oxide (FSG); |
| | and the like |
| Non-polymeric insulators | tris (hydroxymethyl) nitromethane, |
| | tetraoctylammonium bromide, lauric |
| | acid, tetrocosane acid, 3-methyl-2- |
| | phenylvaleric acid, eicosane, |
| | tetracosane, triactane, propyl |
| | gallate, 1,2,5,6,9,10- |
| | hexabromocyclododecane, quinacrine |
| | dihydrochloride dihydrate, dioctyl |
| | phthalate, dioctyl adipate, |
| | phosphates, diethyl phthalate, |
| | dibutyl phthalate, propylene glycol, |
| | triacetin, glycerin, |
| | tetrabutylammonium chloride or |
| | bromide, hexafluorophosphate, and |
| | tributylhexadecylphosphonium bromide |

As used herein the term “material” includes a single homogenous species (e.g., gold, copper, a single polymeric species) as well as heterogeneous materials (e.g., an inorganic conductor such as gold covalently linked to an insulating thiol material). In one aspect, the sensor comprises a sensing area between two conductive leads comprising a region of a first material having a first conductivity, and a region of a second material having a second conductivity, wherein the conductivity of the second material is more resistive (e.g., at least 2 fold, 3 fold, 4 fold, 5 fold, 10 fold less conductive) compared to the first material. In a specific embodiment, wherein a sensor comprises regions of a conductive material and regions of a capped-insulating material (e.g., Au—S—C₆), the capped-insulating material will have a conductivity that is at least 2 fold less conductive than the conductive material in the sensor. For example, as discussed more fully below, an Au—S—C₆ material will be considered a non-conductive material when the conductive material of the sensor is gold; however, the Au—S—C₆ material will be considered conductive when the non-conductive material of the sensor is glass.

In certain other embodiments, the non-conductive material is a conductive particle, such as a colloidal nanoparticle that is capped with discrete insulating materials. Such non-conductive capped-nanoparticles are typically capped with long chain ligands (e.g., alkyls). These ligands i.e., insulating organic ligand caps, can be functionalized, thereby being suitable for detecting a variety of chemical analytes.

In one aspect of the disclosure, inorganic insulating materials are used in the sensors of the disclosure. In another aspect, non-polymer insulating materials are used in the sensor of the disclosure. Examples of inorganic and non-polymeric insulating materials include those in Table 4. Also include are combinations such as, for example, tetraoctylammonium bromide/dioctyl phthalate, Lauric acid/dioctyl phthalate, Tetracosane acid/dioctyl phthalate, tetracosane/dioctyl phthalate, 1,2,5,6,9,10-hexabromocyclododecane/dioctyl phthalate, and quinacrine dihydrochloride dihydrate/dioctyl phthalate.

The sensors can be fabricated by many techniques such as, but not limited to, solution casting, suspension casting, and mechanical mixing. In general, solution cast routes are advantageous because they provide homogeneous structures and ease of processing. With solution cast routes, resistor elements may be easily fabricated by spin, spray or dip coating. Suspension casting provides the possibility of spin, spray or dip coating to provide heterogeneous structures. With mechanical mixing, there are no solubility restrictions since it involves only the physical mixing of the resistor components, but device fabrication is more difficult since spin, spray and dip coating are no longer possible. Using any one or more of these techniques a plurality of substrates can be simultaneously or individually coated with a composition comprising a conductive material and an inorganic non-conductive material and/or a non-polymeric non-conductive material. A more detailed discussion of each of these follows.

For systems where both the conducting and non-conducting material or their reaction precursors are soluble in a common solvent, the chemiresistors can be fabricated by solution casting. The oxidation of pyrrole by phosphomolybdic acid represents such a system. In this reaction, the phosphomolybdic acid and pyrrole are dissolved in THF and polymerization occurs upon solvent evaporation. This allows for THF soluble non-conductive materials to be dissolved into this reaction mixture thereby allowing the blend to be formed in a single step upon solvent evaporation. The choice of non-conductive materials in this route is, of course, limited to those that are soluble in the reaction media. For example, poly(pyrrole) reactions were performed in THF, but this reaction should be generalizable to other non-aqueous solvent such as acetonitrile or ether. A variety of permutations on this scheme are possible for other conducting polymers. Certain conducting polymers, such as substituted poly(cyclooctatetraenes), are soluble in their undoped, nonconducting state in solvents such as THF or acetonitrile. Consequently, the blends between the undoped material and non-conductive polymer can be formed from solution casting. After which, the doping procedure (exposure to I₂ vapor, for instance) can be performed on the blend to render material conductive. The choice of non-conductive material is selected based upon its solubility in the solvents that the conducting material is soluble in and to those stable to further reactions (e.g., doping reactions). Certain conducting polymers, for example, can also be synthesized via a soluble precursor polymer. In these cases, blends between the precursor polymer and the non-conducting material can first be formed followed by chemical reaction to convert the precursor polymer into the desired conducting polymer. For instance poly(p-phenylene vinylene) can be synthesized through a soluble sulfonium precursor. Blends between this sulfonium precursor and the non-conductive material can be formed by solution casting. After which, the blend can be subjected to thermal treatment under vacuum to convert the sulfonium precursor to the desired poly(phenylene vinylene).

In suspension casting, one or more of the components of the resistor is suspended and the others dissolved in a common solvent. Suspension casting is a rather general technique applicable to a wide range of species, such as carbon blacks or colloidal metals, which can be suspended in solvents by vigorous mixing or sonication. In one application of suspension casting, the non-conductive material is dissolved or suspended in an appropriate solvent (such as THF, acetonitrile, water, and the like). The conductive material is then dissolved (if the non-conductive material is suspended) or suspended (if the non-conductive material is dissolved) in this solution and the resulting mixture is used to make sensors by dip coating.

Mechanical mixing is suitable for all of the conductive/non-conductive combinations possible. In this technique, the materials are physically mixed in a ball-mill or other mixing device. For instance, carbon black: non-conductive material composites are readily made by ball-milling. When the non-conductive material can be melted or significantly softened without decomposition, mechanical mixing at elevated temperature can improve the mixing process. Alternatively, composite fabrication can sometimes be improved by several sequential heat and mix steps.

Once fabricated, the individual elements can be optimized for a particular application by varying their chemical make up and morphologies. The chemical nature of the resistors determines to which analytes they will respond and their ability to distinguish different analytes. The relative ratio of conductive to non-conductive components determines the magnitude of the response. The film morphology is also important in determining response characteristics. For instance, thin films respond more quickly to analytes than do thick ones. Hence, with an empirical catalogue of information on chemically diverse sensors made with varying ratios of non-conductive to conducting components and by differing fabrication routes, sensors can be chosen that are appropriate for the analytes expected in a particular application, their concentrations, and the desired response times. Further optimization can then be performed in an iterative fashion as feedback on the performance of an array under particular conditions becomes available.

The resistor may itself form a substrate for attaching the lead or the resistor. For example, the structural rigidity of the resistors may be enhanced through a variety of techniques: chemical or radiation cross-linking of conductive polymer components (dicumyl peroxide radical cross-linking, UV-radiation cross-linking, sulfur cross-linking, e-beam cross-linking and the like), the incorporation of polymers or other materials into the resistors to enhance physical properties (for instance, the incorporation of a high molecular weight, high Tₘ polymer), the incorporation of the resistor elements into supporting matrices such as clays or polymer networks (forming the resistor blends within poly-(methylmethacrylate) networks or within the lamellae of montmorillonite, for instance), and the like. In another embodiment, the resistor is deposited as a surface layer on a solid matrix/support which provides support for the leads. Typically, the matrix/support is a chemically inert, non-conductive substrate such as a glass or ceramic.

Sensor arrays particularly well-suited to scaled up production are fabricated using IC design technologies. For example, the chemiresistors can easily be integrated onto the front end of a simple amplifier interfaced to an A/D converter to efficiently feed the data stream directly into a neural network software or hardware analysis section. Micro-fabrication techniques can integrate the chemiresistors directly onto a microchip which contains the circuitry for analogue signal conditioning/processing and then data analysis. This provides for the production of millions of incrementally different sensor elements in a single manufacturing step using, for example, ink-jet technology. Controlled compositional gradients in the chemiresistor elements of a sensor array can be induced in a method analogous to how a color ink-jet printer deposits and mixes multiple colors. However, in this case rather than multiple colors, a plurality of different conductive and/or non-conductive materials in solution which can be deposited are used. A sensor array of a million distinct elements only requires a 1 cm×1 cm sized chip employing lithography at the 10 μm feature level, which is within the capacity of conventional commercial processing and deposition methods. This technology permits the production of sensitive, small-sized, stand-alone chemical sensors.

Typical sensor arrays have a predetermined inter-sensor variation in the structure or composition of the non-conductive regions. The variation may be quantitative and/or qualitative. For example, the concentration of the non-conductive regions of the sensors can be varied across sensors. Alternatively, a variety of different materials may be used in different sensors. An electronic nose for detecting an analyte in a fluid is fabricated by electrically coupling the sensor leads of an array of compositionally different sensors to an electrical measuring device. The device measures changes in resistivity at each sensor of the array, typically simultaneously and usually over time. Frequently, the device includes signal processing means and is used in conjunction with a computer and data structure for comparing a given response profile to a structure-response profile database for qualitative and quantitative analysis. Typically such a nose comprises at least ten, usually at least 100, and often at least 1000 different sensors though with mass deposition fabrication techniques described herein or otherwise known in the art, arrays of on the order of at least 10⁶ sensors are readily produced.

In operation, each resistor provides a first electrical resistance between its conductive leads when the resistor is contacted with a first fluid comprising a chemical analyte at a first concentration, and a second electrical resistance between its conductive leads when the resistor is contacted with a second fluid comprising the same chemical analyte at a second different concentration. The fluids may be liquid or gaseous in nature. The first and second fluids may reflect samples from two different environments, a change in the concentration of an analyte in a fluid sampled at two time points, a sample and a negative control, and the like. The sensor array necessarily comprises sensors which respond differently to a change in an analyte concentration, i.e. the difference between the first and second electrical resistance of one sensor is different from the difference between the first and second electrical resistance of another sensor.

In one embodiment, the temporal response of each sensor (resistance as a function of time) is recorded. The temporal response of each sensor may be normalized to a maximum percent increase and percent decrease in resistance which produces a response pattern associated with the exposure of the analyte. By iterative profiling of known analytes, a structure-function database correlating analytes and response profiles is generated. Unknown analyte may then be characterized or identified using response pattern comparison and recognition algorithms. Accordingly, analyte detection systems comprising sensor arrays, an electrical measuring devise for detecting resistance across each chemiresistor, a computer, a data structure of sensor array response profiles, and a comparison algorithm are provided. In another embodiment, the electrical measuring device is an integrated circuit comprising neural network-based hardware and a digital-analog converter multiplexed to each sensor, or a plurality of DACs, each connected to different sensor(s).

In one mode of operation with an array of sensors, each sensor provides a first electrical signal when the sensor is contacted with a first fluid comprising a first chemical analyte, and a second electrical signal between its conductive leads when the sensor is contacted with a second fluid comprising a second, different chemical analyte. The fluids may be liquid or gaseous in nature. The first and second fluids may reflect samples from two different environments, a change in the concentration of an analyte in a fluid sampled at two time points, a sample and a negative control, etc. The sensor array necessarily comprises sensors that respond differently to a change in an analyte concentration or identity, i.e., the difference between the first and second electrical signal of one sensor is different from the difference between the first and second electrical signals of another sensor.

In one embodiment, the temporal response of each sensor (for example, signal as a function of time) is recorded. The temporal response of each sensor can be normalized to a maximum percent increase and percent decrease in signal that produces a response pattern associated with the exposure of the analyte. By iterative profiling of known analytes, a structure-function database correlating analytes and response profiles is generated. Unknown analytes can then be characterized or identified using response pattern comparison and recognition algorithms. Accordingly, analyte detection systems comprising sensor arrays, an electrical measuring device for detecting signal at each sensor, a computer, a data structure of sensor array response profiles, and a comparison algorithm are provided. In another embodiment, the electrical measuring device is an integrated circuit comprising neural network-based hardware and a digital-analog converter (DAC) multiplexed to each sensor, or a plurality of DACs, each connected to different sensor(s).

Particular implementations of the invention can include one or more of the following features. Detecting the presence of the analyte can include generating a spatio-temporal response profile indicative of the presence of the analyte based on the spatio-temporal difference between the responses for a first and second sensors. The spatio-temporal response profile can be derived from time information indicating the dependence of sensor response on time. The first sensor can be exposed to the fluid before the second sensor, such that the response of the second sensor is delayed with respect to the response of the first sensor. The first sensor can be exposed to the fluid before the second sensor, such that the response of the second sensor is changed in amplitude with respect to the response of the first sensor. The first sensor can include a sensing material and the response of the first sensor can be greater than the response of the second sensor for an analyte having a high affinity for the sensing material. The first and second sensors can be selected and arranged to provide a first delay between the response of the first sensor and the response of the second sensor upon exposure of the sensor array to a fluid including a first analyte and a second delay between the response of the first sensor and the response of the second sensor upon exposure of the sensor array to a fluid including a second analyte. Measuring the response can include measuring the delay between the response of the first sensor and the response of the second sensor, and the spatio-temporal difference between the responses for the first and second sensors can be derived from the delay. The method can include characterizing the analyte based on the spatio-temporal difference between the responses. Exposing the sensor array to the fluid can include introducing the fluid at a varying flow rate. Generating the spatio-temporal response profile can include generating flow information indicating the dependence of sensor response on flow rate. The sensor array can include a plurality of cross-reactive sensors. The sensor array can include a plurality of sensors selected from the group including surface acoustic wave sensors, quartz crystal resonators, metal oxide sensors, dye-coated fiber optic sensors, dye-impregnated bead arrays, micromachined cantilever arrays, composites having regions of conducting material and regions of non-conductive material, composites having regions of conducting material and regions of conducting or semiconducting organic material, chemically-sensitive resistor or capacitor films, metal-oxide-semiconductor field effect transistors, and bulk organic conducting polymeric sensors. The first and second sensors can include composites having regions of a conducting material and regions of a non-conductive material. The first and second sensors can include composites having regions of two compositionally different conductive materials (e.g., regions of a conducting material and regions of a conducting organic material). The method can include generating a digital representation of the analyte based at least in part on the responses of the first and second sensors. The method can include communicating the digital representation of the analyte to a remote location for analysis.

A wide variety of analytes and fluids may be analyzed by the disclosed sensors, arrays and noses so long as the subject analyte is capable of generating a differential response across a sensor or array of sensors. Analyte applications include broad ranges of chemical classes such as organics such as alkanes, alkenes, alkynes, dienes, alicyclic hydrocarbons, arenes, alcohols, ethers, ketones, aldehydes, carbonyls, carbanions, polynuclear aromatics and derivatives of such organics, e.g. halide derivatives, and the like, biomolecules such as sugars, proteins, nucleic acids, isoprenes and isoprenoids, fatty acids and derivatives, and the like.

Detecting an analyte includes generating a response profile indicative of the presence of the analyte based on changes in a detectable signal from at least one sensor. The response profile can be derived over a period of time (e.g., continuously) due to adsorption or diffusion of the analyte into or on a particular sensor type, or may be obtained by detecting a change in the detectable signal of the sensor at a single time point or plurality of time points (e.g., t=0, t=1 sec, t=2 sec, . . . and the like). By “detectable signal” is meant a change in the sensor from a first state to a second state, which can be visually, electronically or acoustically detected. A detectable signal generated by a sensor upon adsorption by any particular analyte generates a response fingerprint corresponding to the detectable signal from at least one or more sensors. For example, a plurality of sensors allows expanded utility because the signal for an imperfect “key” for one sensor can be recognized through information gathered on another, chemically or physically dissimilar sensor in the array. A distinct pattern of responses produced over the collection of sensors in the array can provide a fingerprint that allows classification and identification of the analyte, whereas, in some instances, such information would not have been obtainable by relying on the signals arising solely from a single sensor or sensing material. The fingerprint of the analyte can include a plurality of different detectable signals and includes variations in degrees or amplitude of a detectable signal. A digital representation of the detectable signal generated by the sensor is created and communicated to a remote location for analysis.

The digital representation of the detectable signal is transmittable over any number of media. For example, such digital data can be transmitted over the Internet in encrypted or in publicly available form. The data can be transmitted over phone lines, fiber optic cables or various air-wave frequencies. The data are then analyzed by a central processing unit at a remote site, and/or archived for compilation of a data set that could be mined to determine, for example, changes with respect to historical mean “normal” values of the breathing air in confined spaces, of human breath profiles, and of a variety of other long term monitoring situations where detection of analytes in a sample is an important value-added component of the data.

A computer can be configured to characterize the analyte based on the fingerprint (e.g., the detectable signal from one or more sensors). By developing a catalogue of information on chemically diverse sensors—made, for example, with varying ratios of semi-conductive, conducting and insulating components and by differing fabrication routes—a database of analyte fingerprints can be created. The identity of the chemical analyte may or may not be known. Accordingly, an analyte fingerprint in the database can be associated with its identity or a number of other criteria, including for example, where the analyte fingerprint was obtained, the temperature, subject, disease state, location and other criteria associated with a fingerprint can be contained in the database. In addition, sensors can be chosen that are appropriate for the analytes expected in a particular application, their concentrations and the desired response times.

By profiling or fingerprinting analytes (both known and unknown) a structure-function-association database correlating analytes and fingerprints can be generated. Unknown analytes can then be characterized or identified using response pattern comparison and recognition algorithms. The invention is not limited to any particular algorithm for comparing response fingerprints as one skilled in the art will recognize a number of ways to implement a comparison algorithm. For example, data analysis can be performed using standard chemometric methods such as principal component analysis and SIMCA, which are available in commercial software packages that run on a PC or which are easily transferred into a computer running a resident algorithm or onto a single analysis chip either integrated into, or working in conjunction with, the sensor electronics. The Fisher linear discriminant is one algorithm for analysis of the data, as described in more detail below. More sophisticated algorithms and supervised or unsupervised neural network based learning/training methods can be applied as well (Duda, R. O.; Hart, P. E. Pattern Classification and Scene Analysis; John Wiley & Sons: New York, 1973, pp. 482).

A signal profile (such as a resistance fingerprint) that is generated by an array of differentially responsive sensors can be used to identify analyte properties. The change in the electrical resistance of a chemically-sensitive resistor in such a sensing array can be related to the sorption of a molecule of interest to the non-conductive regions of the chemically-sensitive resistor. The signals produced by a plurality of chemically-sensitive resistors having individual sorption criteria thus provide information on a number of chemically important properties, such as the hydrophobicity, molecular size, polarity, and hydrogen-bonding interactions of a molecule of interest, thus, for example, creating a resistance profile or fingerprint of the molecule of interest based upon its chemical properties.

Accordingly, a wide variety of commercial applications are available for the sensors arrays and electronic noses including, but not limited to, environmental toxicology and remediation, biomedicine, materials quality control, food and agricultural products monitoring, heavy industrial manufacturing, ambient air monitoring, worker protection, emissions control, product quality testing, leak detection and identification, oil/gas petrochemical applications, combustible gas detection, H₂S monitoring, hazardous leak detection and identification, emergency response and law enforcement applications, illegal substance detection and identification, arson investigation, enclosed space surveying, utility and power applications, emissions monitoring, transformer fault detection, food/beverage/agriculture applications, freshness detection, fruit ripening control, fermentation process monitoring and control applications, flavor composition and identification, product quality and identification, refrigerant and fumigant detection, cosmetic/perfume/fragrance formulation, product quality testing, personal identification, chemical/plastics/pharmaceutical applications, solvent recovery effectiveness, perimeter monitoring, product quality testing, hazardous waste site applications, fugitive emission detection and identification, transportation, hazardous spill monitoring, refueling operations, shipping container inspection, diesel/gasoline/aviation fuel identification, building/residential natural gas detection, formaldehyde detection, smoke detection, fire detection, automatic ventilation control applications (cooking, smoking, etc.), air intake monitoring, hospital/medical anesthesia & sterilization gas detection, infectious disease detection and breath applications, body fluids analysis, pharmaceutical applications, drug discovery, telesurgery, anaesthetic detection, automobile oil or radiator fluid monitoring, breath alcohol analyzers, explosives detection, fugitive emission identification, medical diagnostics, fish freshness, detection and classification of bacteria and microorganisms both in vitro and in vivo for biomedical uses and medical diagnostic uses, and the like. Another application for the sensor-based fluid detection device in engine fluids is an engine diagnostics for air/fuel optimization, diesel fuel quality, volatile organic carbon measurement (VOC), fugitive gases in refineries, food quality, halitosis, soil and water contaminants, air quality monitoring, leak detection, fire safety, chemical weapons identification, use by hazardous material teams, breathalyzers, ethylene oxide detectors and anaesthetics.

In one aspect, a general method for using the disclosed sensors, arrays and electronic noses, for detecting the presence of an analyte in a fluid involves resistively sensing the presence of an analyte in a fluid with a chemical sensor comprising first and second conductive leads electrically coupled to and separated by a sensing area comprising a conductive material and a non-conductive material. The method includes measuring a resistance between the conductive leads when the resistor is contacted with a fluid comprising an analyte.

The invention also provides a sensing apparatus. The apparatus is compact and can be a handheld device. The handheld device can be used to measure or identify one or more analytes in a medium such as vapor, liquid, gas, solid, and others as described herein. Some embodiments of the handheld device include at least two sensors (i.e., an array of sensors).

A handheld device of the disclosure is versatile and meets the needs of a wide range of applications in various industries. In certain embodiments, the device is designed as a slim handheld, portable device with various functionalities. In another embodiment, the device is designed as a portable field tool with full functionality. The handheld device typically includes an internal processor for processing samples and reporting data. Optionally, the device can be coupled to a computer, such as a personal computer, for access to set-up and advanced features and for transfer of data files. In some embodiments, sections of the handheld device are disposed within modules that can be installed, swapped, and replaced as necessary. For example, a sensor module, sampling wand or nose, battery pack, filter, electronics, and other components, can be modularized. This modular design increases utility, enhances performance, reduces cost, and provides additional flexibility and other benefits.

A handheld sensing apparatus can comprise a housing, a sensor module, a sample chamber, and an analyzer. The sensor module can comprise at least two sensors of the disclosure. The sample chamber is defined by the housing or the sensor module, or both, and incorporates an inlet port and an outlet port. The sensors are located within or adjacent to the sample chamber. The analyzer is configured to analyze a particular response from the sensors and to identify or quantify, based on the particular response, analytes within the test sample. The sensor module can be removably mounted in the receptacle of the housing.

The following examples are offered by way of illustration and not by way of limitation.

### EXAMPLES

### Example 1

### Conductive Polymer/Non-Conductive Polymer Sensors

Polymer Synthesis. Poly(pyrrole) films used for conductivity, electrochemical, and optical measurements were prepared by injecting equal volumes of N₂-purged solutions of pyrrole (1.50 mmoles in 4.0 ml dry tetrahydrofuran) and phosphomolybdic acid (0.75 mmoles in 4.0 ml tetrahydrofuran) into a N₂-purged test tube. Once the two solutions were mixed, the yellow phosphomolybdic acid solution turned dark green, with no observable precipitation for several hours. This solution was used for film preparation within an hour of mixing.

Sensor Fabrication. Polymer-poly(pyrrole) blend sensors were made by mixing two solutions, one of which contained 0.29 mmoles pyrrole in 5.0 ml tetrahydrofuran, with the other containing 0.25 mmoles phosphomolybdic acid and 30 mg of non-conductive polymer in 5.0 ml of tetrahydrofuran. The mixture of these two solutions resulted in a w:w ratio of pyrrole to non-conductive polymer of 2:3. An inexpensive, quick method for creating the chemiresistor array elements was accomplished by effecting a cross sectional cut through commercial 22 nF ceramic capacitors (Kemet Electronics Corporation). Mechanical slices through these capacitors revealed a series of interdigitated metal lines (25% Ag:75% Pt), separated by 15 μm, that could be readily coated with conducting polymer. The monomer—polymer—oxidant solutions were then used to dip coat interdigitated electrodes in order to provide a robust electrical contact to the polymerized organic films. After polymerization was complete, the film was insoluble and was rinsed with solvent (tetrahydrofuran or methanol) to remove residual phosphomolybdic acid and unreacted monomer. The sensors were then connected to a commercial bus strip, with the resistances of the various “chemiresistor” elements readily monitored by use of a multiplexing digital ohmmeter.

Instrumentation. Optical spectra were obtained on a Hewlett Packard 8452A spectrophotometer, interfaced to an IBM XT. Electrochemical experiments were performed using a Princeton Applied Research Inc. 173 potentiostat/175 universal programmer. All electrochemical experiments were performed with a Pt flag auxiliary and a saturated calomel reference electrode (SCE). Spin-coating was performed on a Headway Research Inc. photoresist spin coater. Film thicknesses were determined with a Dektak Model 3030 profilometer. Conductivity measurements were performed with an osmium-tipped four point probe (Alessi Instruments Inc., tip spacing=0.050″, tip radii=0.010″). Transient resistance measurements were made with a conventional multimeter (Fluke Inc., “Hydra Data Logger” Meter).

Principal Components Analysis and Multi-linear Least Square Fits. A data set obtained from a single exposure of the array to an odorant produced a set of descriptors (i.e. resistances), dᵢ. The data obtained from multiple exposures thus produced a data matrix D where each row, designated by j, consisted of n descriptors describing a single member of the data set (i.e. a single exposure to an odor). Since the baseline resistance and the relative changes in resistance varied among sensors the data matrix was autoscaled before further processing (19). In this preprocessing technique, all the data associated with a single descriptor (i.e. a column in the data matrix) were centered around zero with unit standard deviation
d′ᵢⱼ=(dᵢⱼ−dᵢ)/σᵢ (1)
where dᵢ is the mean value for descriptor i and σᵢ is the corresponding standard deviation.

Principal components analysis (19) was performed to determine linear combinations of the data such that the maximum variance (defined as the square of the standard deviation) between the members of the data set was obtained in n mutually orthogonal dimensions. The linear combinations of the data resulted in the largest variance (or separation) between the members of the data set in the first principal component (pc₁) and produced decreasing magnitudes of variance from the second to the n^{th} principal component (pc₂-pcₙ). The coefficients required to transform the autoscaled data into principal component space (by linear combination) were determined by multiplying the data matrix, D, by its transpose, D^{T} (i.e. diagnolizing the matrix)(9):
R=D^{T}·D (2)

This operation produced the correlation matrix, R whose diagonal elements were unity and whose off-diagonal elements were the correlation coefficients of the data. The total variance in the data was thus given by the sum of the diagonal elements in R. The n eigenvalues, and the corresponding n eigenvectors, were then determined for R. Each eigenvector contained a set of n coefficients which were used to transform the data by linear combination into one of its n principal components. The corresponding eigenvalue yielded the fraction of the total variance that was contained in that principal component. This operation produced a principal component matrix, P, which had the same dimensions as the original data matrix. Under these conditions, each row of the matrix P was still associated with a particular odor and each column was associated with a particular principal component.

Since the values in the principal components space had no physical meaning, it was useful to express the results of the principal components analysis in terms of physical parameters such as partial pressure and mole fraction. This was achieved via a multi-linear least square fit between the principal component values and the corresponding parameter of interest. A multi-linear least square fit resulted in a linear combination of the principal components which yielded the best fit to the corresponding parameter value. Fits were achieved by appending a column with each entry being unity to the principal component matrix P, with each row, j, corresponding to a different parameter value (e.g. partial pressure), vⱼ, contained in vector V. The coefficients for the best multi-linear fit between the principal components and parameter of interest were obtained by the following matrix operation
C=(p^{T}·P)⁻¹·P^{T}·V (3)
where C was a vector containing the coefficients for the linear combination.

A key to the ability to fabricate chemically diverse sensing elements was the preparation of processable, air stable films of electrically conducting organic polymers. This was achieved through the controlled chemical oxidation of pyrrole (PY) using phosphomolybdic acid (H₃PMo₁₂O₄₀) (20) in tetrahydrofuran:
PY→PY⁺+e⁻ (4)
2PY⁺→PY₂+2H⁺ (5)
H₃PMo₁₂O₄₀+2e⁻+2H⁺→H₅PMo₁₂O₄₀ (6)

The redox-driven or electrochemically-induced polymerization of pyrrole has been explored previously, but this process typically yields insoluble, intractable deposits of poly(pyrrole) as the product (21). The approach was to use low concentrations of the H₃PMo₁₂O₄₀ oxidant (E^{o}=+0.36 V vs. SCE) (20). Since the electrochemical potential of PY⁺/PY is more positive (E^{o}=+1.30 V vs. SCE) (22) than that of H₃PMo₁₂O₄₀/H₅PMo₁₂O₄₀, the equilibrium concentration of PY⁺, and thus the rate of polymerization, was relatively low in dilute solutions (0.19 M PY, 0.09 M H₃PMo₁₂O₄₀). However, it has been shown that the oxidation potential of pyrrole oligomers decreases from +1.20 V to +0.55 to +0.26 V vs. SCE as the number of units increase from one to two to three, and that the oxidation potential of bulk poly(pyrrole) occurs at −0.10 V vs. SCE (23). As a result, oxidation of pyrrole trimers by phosphomolybdic acid is expected to be thermodynamically favorable. This allowed processing of the monomer-oxidant solution (i.e. spin coating, dip coating, introduction of non-conductive polymers and materials, etc.), after which time polymerization to form thin films was simply effected by evaporation of the solvent. The dc electrical conductivity of poly(pyrrole) films formed by this method on glass slides, after rinsing the films with methanol to remove excess phosphomolybdic acid and/or monomer, was on the order of 15-30 S-cm⁻¹ for films ranging from 40-100 nm in thickness.

The poly(pyrrole) films produced in this work exhibited excellent electrochemical and optical properties. For example, FIG. 2 shows the cyclic voltammetric behavior of a chemically polymerized poly(pyrrole) film following ten cycles from −1.00 V to +0.70 V vs. SCE. The cathodic wave at −0.40 V corresponded to the reduction of poly(pyrrole) to its neutral, nonconducting state, and the anodic wave at −0.20 V corresponded to the reoxidation of poly(pyrrole) to its conducting state (24). The lack of additional faradaic current, which would result from the oxidation and reduction of phosphomolybdic acid in the film, suggests that the Keggin structure of phosphomolybdic acid was not present in the film anions (25) and implies that MoO₄², or other anions, served as the poly(pyrrole) counterions in the polymerized films.

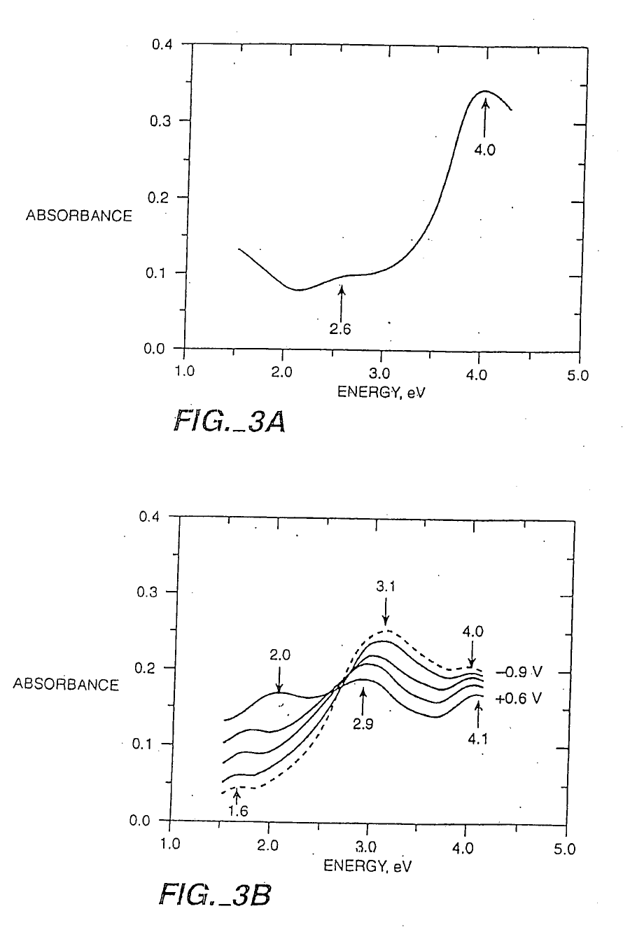

FIG. 3A shows the optical spectrum of a processed polypyrrole film that had been spin-coated on glass and then rinsed with methanol. The single absorption maximum was characteristic of a highly oxidized poly(pyrrole) (26), and the absorption band at 4.0 eV was characteristic of an interband and transition between the conduction and valence bands. The lack of other bands in this energy range was evidence for the presence of bipolaron states (see FIG. 3A), as have been observed in highly oxidized poly(pyrrole) (26). By cycling the film in 0.10 M ((C₄H₉)₄ N)+(ClO₄)⁻—acetonitrile and then recording the optical spectra in 0.10 M KCl—H₂O, it was possible to observe optical transitions characteristic of polaron states in oxidized poly(pyrrole) (see FIG. 3B). The polaron states have been reported to produce three optical transitions (26), which were observed at 2.0, 2.9, and 4.1 eV in FIG. 3B. Upon reduction of the film (c.f. FIG. 3B), an increased intensity and a blue shift in the 2.9 eV band was observed, as expected for the π→π* transition associated with the pyrrole units contained in the polymer backbone (27).

As described herein, various non-conductive polymers are introduced into the polymer films (Table 5).

TABLE 5
Non-conductive polymers used in array elements*

| Sensor | polymers |
|---|---|
| 1 | none |
| 2 | none** |
| 3 | poly(styrene) |
| 4 | poly(styrene) |
| 5 | poly(styrene) |
| 6 | poly(a-methyl styrene) |
| 7 | poly(styrene- |
| | acrylonitrile) |
| 8 | poly(styrene-maleic |
| | anydride) |
| 9 | poly(styrene-allyl |
| | alcohol) |
| 10 | poly(vinyl pyrrolidone) |
| 11 | poly(vinyl phenol) |
| 12 | poly(vinyl butral) |
| 13 | poly(vinyl acetate) |
| 14 | poly(carbonate) |

*Sensors contained 2:3 (w:w) ratio of pyrrole to polymer.
**Film not rinsed to remove excess phosphomolybdic acid.

These inclusions allowed chemical control over the binding properties and electrical conductivity of the resulting conductive/non-conductive polymer blends. Sensor arrays consisted of as many as 14 different elements, with each element synthesized to produce a distinct chemical composition, and thus a distinct sensor response, for its polymer film. The resistance, R, of each film-sensor coated individual sensor was automatically recorded before, during, and after exposure to various odorants. A typical trial consisted of a 60 sec rest period in which the sensors were exposed to flowing air (3.0 liter-min⁻¹), a 60 sec exposure to a mixture of air (3.0 liter-min⁻¹) and air that had been saturated with solvent (0.5-3.5 liter-min⁻¹), and then a 240 sec exposure to air (3.0 liter-min⁻¹).

In an initial processing of the data, the only information used was the maximum amplitude of the resistance change divided by the initial resistance, ΔRₘₐₓ/Rᵢ, of each individual sensor element. Most of the sensors exhibited either increases or decreases in resistance upon exposure to different vapors, as expected from changes in the polymer properties upon exposure to different types chemicals (17-18). However, in some cases, sensors displayed an initial decrease followed by an increase in resistance in response to a test odor. Since the resistance of each sensor could increase and/or decrease relative to its initial value, two values of ΔRₘₐₓ/Rᵢ were reported for each sensor. The source of the bidirectional behavior of some sensor/odor pairs has not yet been studied in detail, but in most cases this behavior arose from the presence of water (which by itself induced rapid decreases in the film resistance) in the reagent-grade solvents used to generate the test odors of this study. The observed behavior in response to these air-exposed, water-containing test solvents was reproducible and reversible on a given sensor array, and the environment was representative of many practical odor sensing applications in which air and water would not be readily excluded.

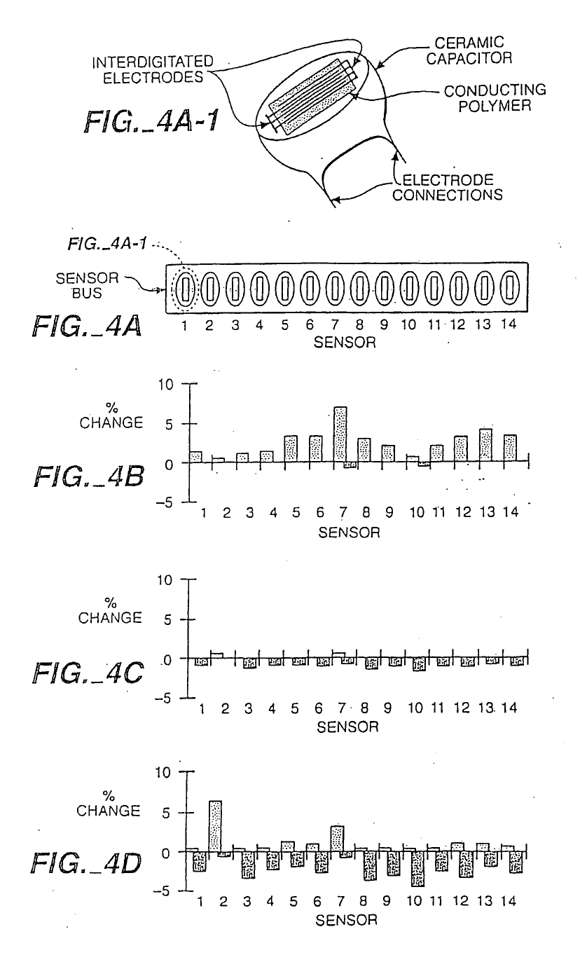

FIG. 4B-D depicts representative examples of sensor amplitude responses of a sensor array (see, Table 3). In this experiment, data were recorded for 3 separate exposures to vapors of acetone, benzene, and ethanol flowing in air. The response patterns generated by the sensor array described in Table 3 are displayed for: (B) acetone; (C) benzene; and (D) ethanol. The sensor response was defined as the maximum percent increase and decrease of the resistance divided by the initial resistance (gray bar and black bar respectively) of each sensor upon exposure to solvent vapor. In many cases sensors exhibited reproducible increases and decreases in resistance. An exposure consisted of: i) a 60 sec rest period in which the sensors were exposed to flowing air (3.0 liter-min⁻¹); ii) a 60 sec exposure to a mixture of air (3.0 liter-min⁻¹) and air that had been saturated with solvent (0.5 liter-min⁻¹); and iii) a 240 sec exposure to air (3.0 liter-min⁻¹). It is readily apparent that these odorants each produced a distinctive response on the sensor array. In additional experiments, a total of 8 separate vapors (acetone, benzene, chloroform, ethanol, isopropyl alcohol, methanol, tetrahydrofuran, and ethyl acetate), chosen to span a range of chemical and physical characteristics, were evaluated over a 5 day period on a 14-element sensor array (Table 3). As discussed below, each odorant could be clearly and reproducibly identified from the others using this sensor apparatus.

Principal component analysis (19) was used to simplify presentation of the data and to quantify the distinguishing abilities of individual sensors and of the array as a whole. In this approach, linear combinations of the ΔRₘₐₓ/Rᵢ data for the elements in the array were constructed such that the maximum variance (defined as the square of the standard deviation) was contained in the fewest mutually orthogonal dimensions. This allowed representation of most of the information contained in data sets shown in FIGS. 4B-D in two (or three) dimensions. The resulting clustering, or lack thereof, of like exposure data in the new dimensional space was used as a measure of the distinguishing ability, and of the reproducibility, of the sensor array.

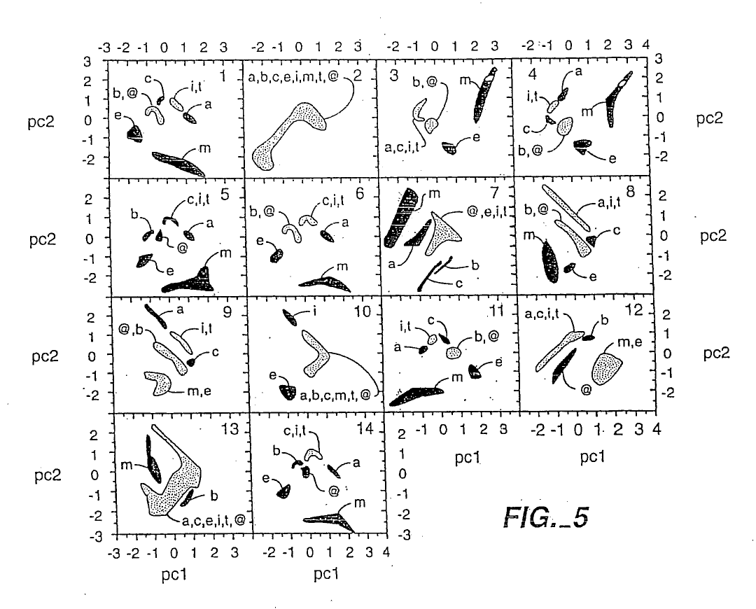

In order to illustrate the variation in sensor response of individual sensors that resulted from changes in the non-conductive polymer, principal component analysis was performed on the individual, isolated responses of each of the 14 individual sensor elements in a typical array (FIG. 5). Data were obtained from multiple exposures to acetone (a), benzene (b), chloroform (c), ethanol (e), isopropyl alcohol (i), methanol (m), tetrahydrofuran (+), or ethyl acetate (@) over a period of 5 days with the test vapors exposed to the array in various sequences. The numbers of the figures refer to the sensor elements described in Table 5. The units along the axes indicate the amplitude of the principal component that was used to describe the particular data set for an odor. The black regions indicate clusters corresponding to a single solvent which could be distinguished from all others; gray regions highlight data of solvents whose signals overlapped with others around it. Exposure conditions were identical to those in FIG. 4.

Since each individual sensor produced two data values, principal components analysis of these responses resulted in two orthogonal principal components; pc1 and pc2. As an example of the selectivity exhibited by an individual sensor element, the sensor designated as number 5 in FIG. 5 (which contained poly(styrene)) confused acetone with chloroform, isopropyl alcohol, and tetrahydrofuran. It also confused benzene with ethyl acetate, while easily distinguishing ethanol and methanol from all other solvents. Changing the non-conductive polymer to poly (É-methyl styrene) (sensor number 6 in FIG. 5) had little effect on the spatial distribution of the responses with respect to one another and with respect to the origin. Thus, as expected, a rather slight chemical modification of the non-conductive polymer had little effect on the relative variance of the eight test odorants. In contrast, the addition of a cyano group to the non-conductive polymer, in the form of poly(styrene-acrylonitrile), (sensor number 7 in FIG. 5), resulted in a larger contribution to the overall variance by benzene and chloroform, while decreasing the contribution of ethanol. Changing the substituent group in the non-conductive polymer to a hydrogen bonding acid (poly(styrene-allyl alcohol), sensor number 9 in FIG. 5) increased the contribution of acetone to the overall variance while having little effect on the other odors, with the exception of confusing methanol and ethanol. These results suggest that the behavior of the sensors can be systematically altered by varying the chemical composition of the non-conductive material.

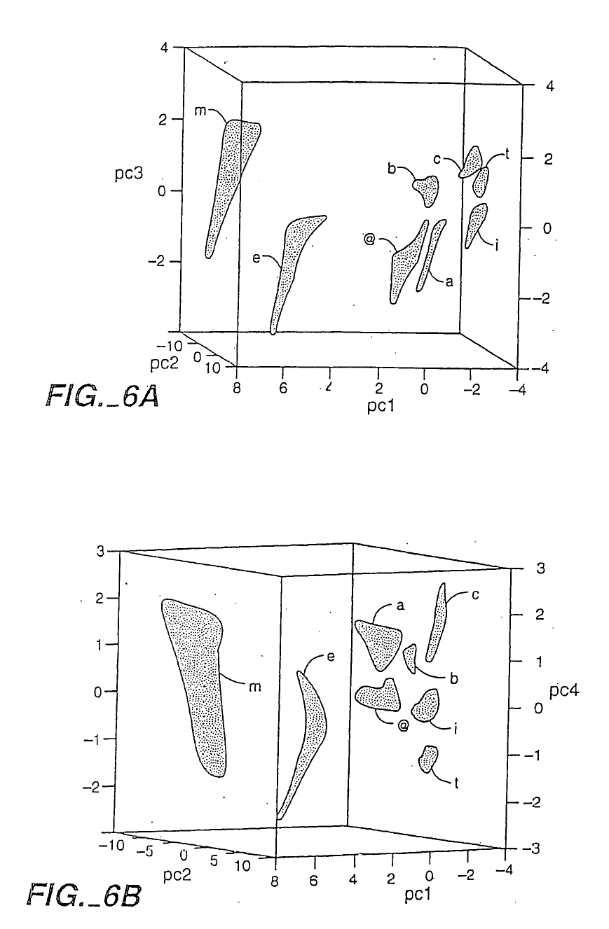

FIG. 6 shows the principal components analysis for all 14 sensors described in Table 5 and FIGS. 4 and 5. When the solvents were projected into a three dimensional odor space (FIG. 6A or 6B), all eight solvents were easily distinguished with the specific array discussed herein. Detection of an individual test odor, based only on the criterion of observing 1% ΔRₘₐₓ/Rᵢ values for all elements in the array, was readily accomplished at the parts per thousand level with no control over the temperature or humidity of the flowing air. Further increases in sensitivity are likely after a thorough utilization of the temporal components of the ΔRₘₐₓ/Rᵢ data as well as a more complete characterization of the noise in the array.

Also investigated was the suitability of this sensor array for identifying the components of certain test mixtures. This task is greatly simplified if the array exhibits a predictable signal response as the concentration of a given odorant is varied, and if the responses of various individual odors are additive (i.e. if superposition is maintained). When a 19-element sensor array was exposed to a number, n, of different acetone concentrations in air, the (CH₃)₂CO concentration was semi-quantitatively predicted from the first principal component. This was evident from a good linear least square fit through the first three principal components.

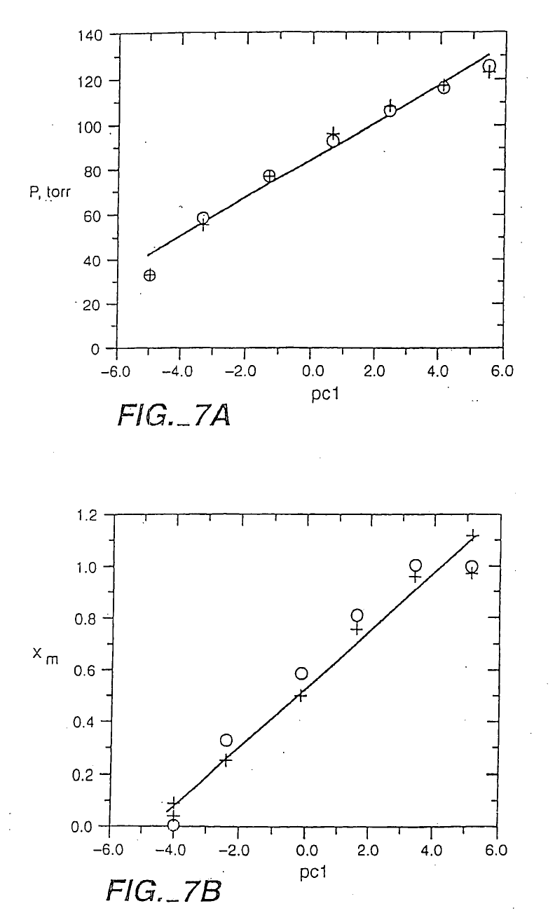

The same sensor array was also able to resolve the components in various test methanol-ethanol mixtures (29). As shown in FIG. 7B, a linear relationship was observed between the first principal component and the mole fraction of methanol in the liquid phase, xₘ, in a CH₃OH—C₂H₅OH mixture, demonstrating that superposition held for this mixture/sensor array combination. Furthermore, although the components in the mixture could be predicted fairly accurately from just the first principal component, an increase in the accuracy could be achieved using a multi-linear least square fit through the first three principal components. This relationship held for CH₃OH/(CH₃OH+C₂H₅OH) ratios of 0 to 1.0 in air-saturated solutions of this vapor mixture. The conducting polymer-based sensor arrays could therefore not only distinguish between pure test vapors, but also allowed analysis of concentrations of odorants as well as analysis of binary mixtures of vapors.

In summary, the results presented advance the area of analyte sensor design. A relatively simple array design, using only a multiplexed low-power dc electrical resistance readout signal, has been shown to readily distinguish between various test odorants. Such conducting polymer-based arrays are simple to construct and modify, and afford an opportunity to effect chemical control over the response pattern of a vapor. For example, by increasing the ratio of non-conductive polymer to conducting polymer, it is possible to approach the percolation threshold, at which point the conductivity exhibits a very sensitive response to the presence of the sorbed molecules. Furthermore, producing thinner films will afford the opportunity to obtain decreased response times, and increasing the number of non-conductive polymers and polymer backbone motifs will likely result in increased diversity among sensors. This type of polymer based array is chemically flexible, is simple to fabricate, modify, and analyze, and utilizes a low power dc resistance readout signal transduction path to convert chemical data into electrical signals. It provides a new approach to broadly-responsive odor sensors for fundamental and applied investigations of chemical mimics for the mammalian sense of smell. Such systems are useful for evaluating the generality of neural network algorithms developed to understand how the mammalian olfactory system identifies the directionality, concentration, and identity of various odors.

### Example 2

### Carbon Black-Non-Conductive Polymer Sensors

Sensor Fabrication. Individual sensor elements were fabricated in the following manner. Each non-conductive polymer (80 mg, see Table 6) was dissolved in 6 ml of THF.

TABLE 6

| Sensor # | Non-conductive Polymer |
|---|---|
| 1 | poly(4-vinyl phenol) |
| 2 | poly(styrene - allyl alcohol) |
| 3 | poly(α-methyl styrene) |
| 4 | poly(vinyl chloride - vinyl acetate) |
| 5 | poly(vinyl acetate) |
| 6 | poly(N-vinyl pyrrolidone) |
| 7 | poly(bisphenol A carbonate) |
| 8 | poly(styrene) |
| 9 | poly(styrene-maleic anhydride) |
| 10 | poly(sulfone) |

Then, 20 mg of carbon black (BP 2000, Cabot Corp.) was suspended with vigorous mixing. Interdigitated electrodes (the cleaved capacitors previously described) were then dipped into this mixture and the solvent allowed to evaporate. A series of such sensor elements with differing non-conductive polymers were fabricated and incorporated into a commercial bus strip which allowed the chemiresistors to be easily monitored with a multiplexing ohmmeter.

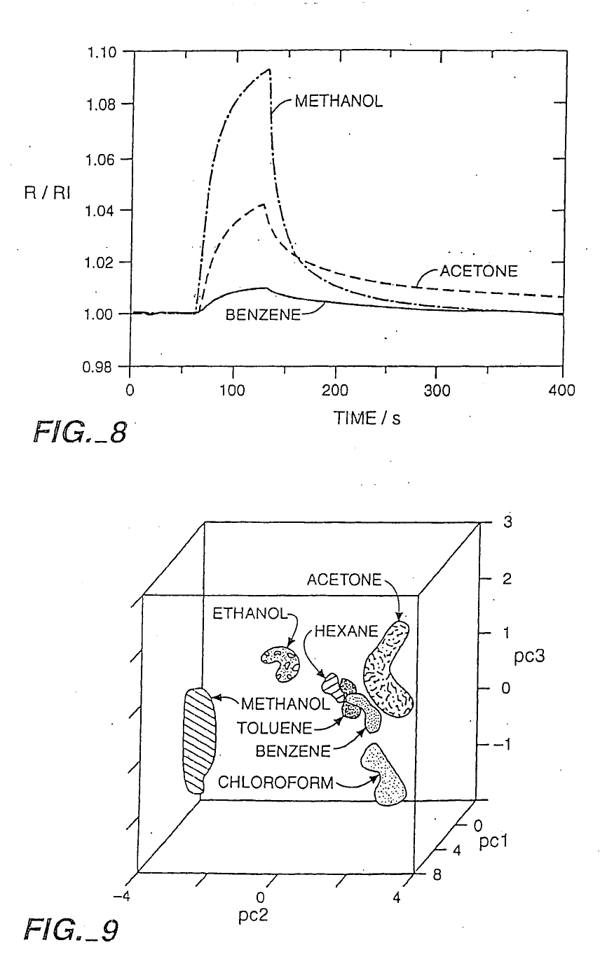

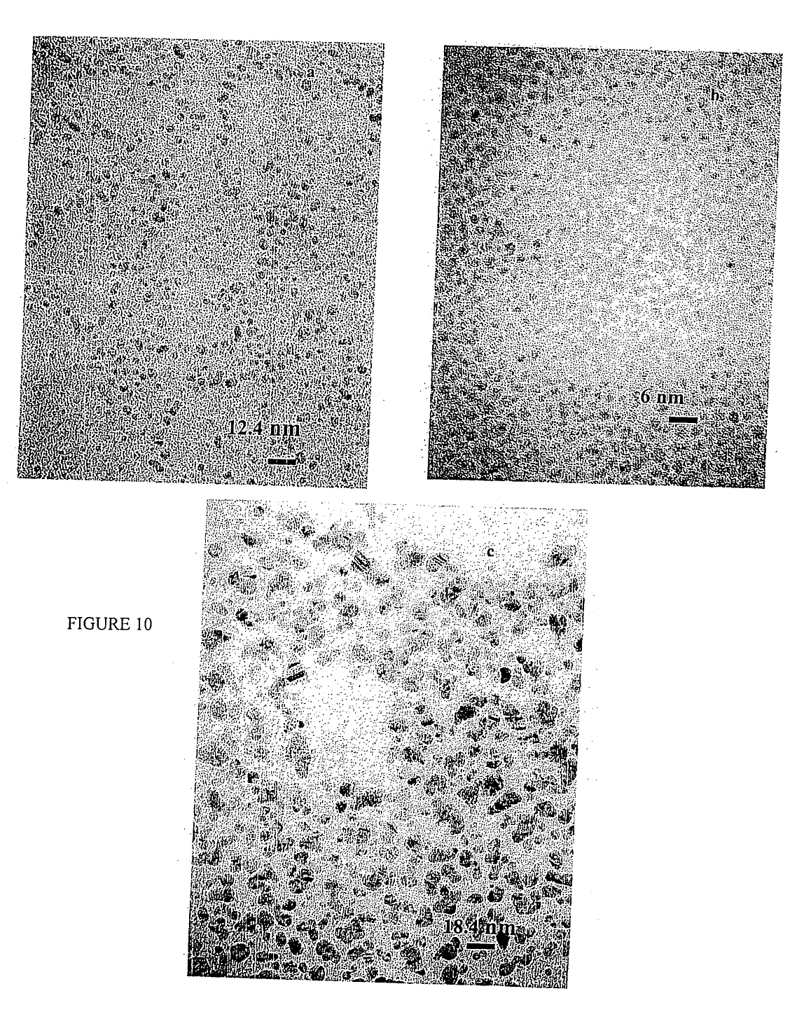

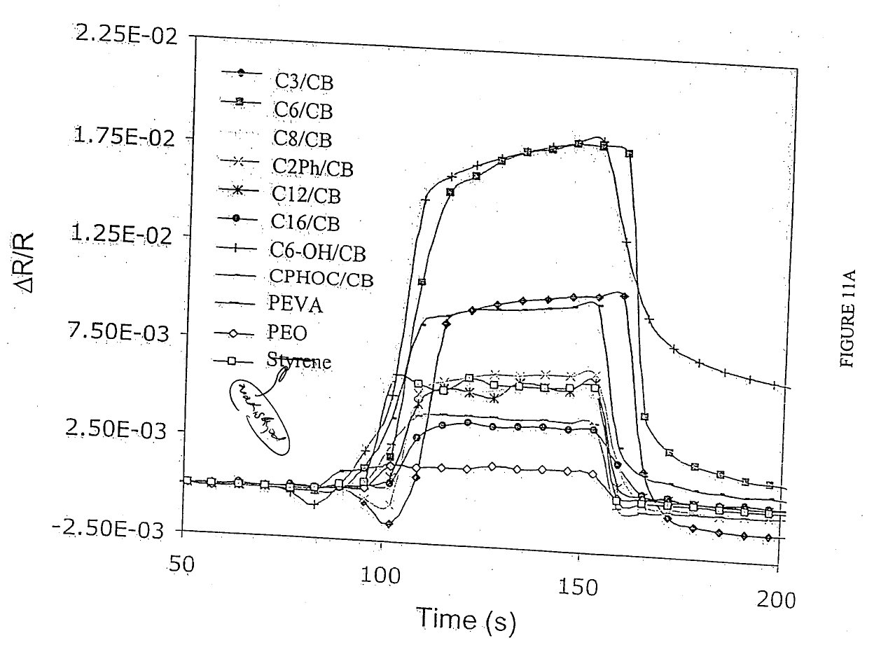

Sensor Array Testing. To evaluate the performance of the carbon-black-polymer composite sensors, arrays with as many as twenty elements were exposed to a series of analytes. A sensor exposure consisted of (1) a sixty second exposure to flowing air (6 liter min⁻¹), (2) a sixty second exposure to a mixture of air (6 liter min⁻¹) and air that had been saturated with the analyte (0.5 liter min⁻¹), (3) a five minute recovery period during which the sensor array was exposed to flowing air (6 liter min⁻¹). The resistance of the elements were monitored during exposure, and depending on the thickness and chemical make-up of the film, resistance changes as large as 250% could be observed in response to an analyte. In one experiment, a element sensor array consisting of carbon-black composites formed with a series of non-conductive polymers (see Table 6) was exposed to acetone, benzene, chloroform, ethanol, hexane, methanol, and toluene over a two day period. A total of 58 exposures to these analytes were performed in this time period. In all cases, resistance changes in response to the analytes were positive, and with the exception of acetone, reversible (see FIG. 8). The maximum positive deviations were then subjected to principal components analysis in a manner analogous to that described for the poly(pyrrole) based sensors. FIG. 9 shows the results of the principal components analysis for the entire 10-element array. With the exception of overlap between toluene with benzene, the analytes were distinguished from one and other.

### Example 3

### Carbon Black-Non-Conductive Nanoparticle Sensors

Two kinds of non-polymeric, non-conductive materials were prepared. In one aspect, colloids, alkylthiol-capped gold nanoparticles were used and in another aspect, carboxylic acid capped TiO₂ colloids were used.

Chemicals. Toluene was purchased from EM Science. Sodium borohydride (NaBH₄), hydrogen tetrachloroaurate trihydrate (HauCl₄.3H₂O, A.C.S. reagent), tetraoctylammonium bromide ((C₈H₁₇)₄NBr, ≧99%), 1-propylthiol (99%), 1-Hexanethiol (95%), 1-octanethiol (98.5%), 1-Dodecanethiol (24 98%), 1-Hexanecanethiol (92%), benzeneethanethiol (98%), 6-mercapto-1-hexanol (97%), 4-methoxy-α-toluenethiol (90%), octanoic acid (C₇COOH), lauric acid (C₁₁COOH), tetracosane acid (C₂₃COOH) and the test analytes, (n-hexane, tetrahydrofuran (THF), ethanol, ethyl acetate, n-heptane, n-octane, cyclo-hexane and iso-octane,) were obtained from Aldrich. All the reagents and solvents were used without further purification. 18 MΩ-cm resistivity deionized water was obtained from a Barnstead Nanopure purification system.

Black Pearls 2000 (BP 2000), a furnace carbon black material donated by Carbot Co. (Billerica, Mass.) was used as received.

Preparation of Gold Nanocrystal Solutions. Gold nanoparticles capped with eight different alkanethiols were prepared by reduction of AuCl₄⁻ in the presence of thiol. The thiols used are shown in Scheme 1. For clarity, propylthiol, hexanethiol, octanethiol, dodecanethiol, hexanecanethiol, benzeneethanethiol, 6-mercapto-1-hexanol, 4-methoxy-α-toluenethiol capped gold nanoparticles are represented as Au—S—C₃, Au—S—C₆, Au—S—C₈, Au—S—Cl₂, Au—S—C₁₆, Au—S—C₂Ph, Au—S—C₆OH and Au—S—CPhOC, respectively. Alkylthiol-capped gold nanoparticles were synthesized as described by Brust et al. (J. Chem. Soc. Chem. Comm. 7:801-802, 1994) with the use of a phase-transfer reagent, tetraoctylammonium bromide. Briefly, 4.56 g of (C₈H₁₇)₄NBr was dissolved into 167 ml of toluene in a 2000 mL round bottom flask. Then a solution containing 0.8025 g of HAuCl₄.3H₂O dissolved into 62.5 mL of deionized water was added. The resulting biphasic mixture was stirred vigorously while a solution containing one equivalent of alkylthiol (HAuCl₄.3H₂O: thiol=1:1) in 2 mL of toluene was added. Finally a solution containing 0.787 g of NaBH₄ dissolved into 52.5 mL of water was added dropwise into the vigorously stirred mixture over the course of ≈180 s, during which color developed. After stirring for 3 h, the organic phase was separated, transferred to a separatory funnel, and rinsed three times with 100 mL of deionized water. The soluble product remaining in the organic phase was concentrated using rotary evaporation to a volume of ≈4 mL, and precipitated by addition of 800 mL of ethanol at 10° C. After settling overnight, the clear supernatant was decanted and the settled product was collected by centrifugation followed by washing with fresh ethanol and drying. This crude product was redissolved in 3-4 ml of toluene and reprecipitated by dropwise addition into 200 mL of rapidly stirred ethanol. After settling overnight at 10° C., the 200 mL suspension was centrifuged. The precipitate was washed with fresh ethanol, vacuum dried and redissolved into a small amount of (≈10 mL) of toluene. The solution was stored in at 10° C. until needed.

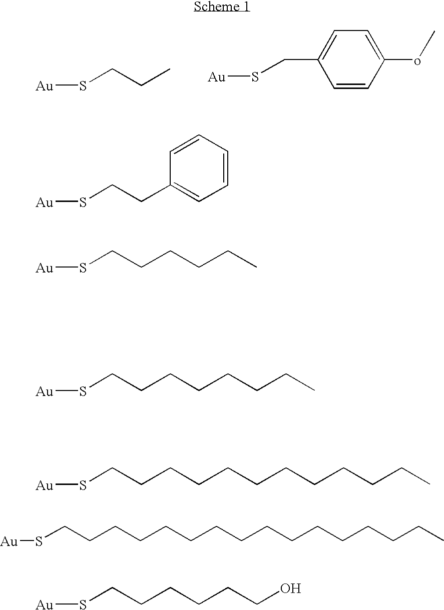

Au—S—C₆OH was obtained by similar method described above with slight modification. After the reaction of HAuCl₄.3H₂O with 6-mercapto-1-hexanol (97%), the aqueous phase of the biphasic mixture was separated and rinsed three time with 100 mL of toluene. The soluble product remaining in the water was concentrated and dried using rotary evaporation, dissolved into ˜4 ml of ethanol and precipitated by addition of 800 mL of toluene at 10° C. After settling overnight, the clear supernatant was decanted and the settled product was collected by centrifugation followed by washing with fresh toluene and drying. This crude product was redissolved in 3-4 ml of ethanol and reprecipitated by dropwise addition into 200 mL of rapidly stirred toluene. After settling overnight at 10° C., the 200 mL suspension was centrifuged. The precipitate was washed with fresh toluene, vacuum dried and redissolved into a small amount of (≈10 mL) of ethanol. The solution was stored in at 10° C. until needed.

The identity of the gold nanocrystals was confirmed by high-resolution TEM, FTIR and NMR spectra.

Preparation of Carboxylic Acid Capped TiO₂ Colloids. About 18.5 ml of high-purity titanium (IV) isopropoxide (99.9%, Aldrich) was diluted in about 300 ml of 2-propanol (approximately 0.2 M titanium isopropoxide in 2-propanol). Hydrolysis of the clear mixture was then performed by the dropwise addition of an aqueous acidic solution (HNO₃, pH of 2-3) at the rate of 1 drop/min under constant stirring to ensure complete hydrolysis of titanium isopropoxide. The clear resulting solution was aged by continuous stirring for at least one to two days. The core colloids can include, for example, ZnO, CdSe and the like and so on so long as they can be surface modified with an organic ligand. The functional group of the ligand will typically determine the sensor's specificity. Organic ligands capped TiO₂ colloids were prepared by the reaction of carboxylic acid with as prepared TiO₂ nano-particles in acidic environmental. For clarity, the octanoic acid, lauric acid, hexadecanoic acid, 12-bromododecanoic acid, tetracosane acid and cis-5-dodecanoic acid capped TiO₂ particles are represented as TiO₂—C₈, TiO₂—C₁₂, TiO₂—C₁₆, TiO₂—Cl₂Br, TiO₂—C₂₄, TiO₂—C₄C═CC₆, respectively. These organic ligand-capped TiO₂ colloids are natural insulators of all cap lengths. To monitor the sensor responses of the film to the various organic vapors, 10% weight of carbon black was also added to solutions of the TiO₂ colloids prior to casting of the sensor film with a 0.8 mm gap between the contacts.

50 mg carboxylic acid (1:1 mole ratio to the calculated TiO₂ amount in the solution) was dissolved in ˜2-3 mL acetone by sonicating the solution for over one hour. Then the dissolved carboxylic acid was dropwise added into the sonicated or vigorously stirred TiO₂ solution. After stirring or sonicating for one day, white capped TiO₂ particles in the solution were observed and collected by centrifuging. The collected particles were washed with water to remove HNO₃, then ethanol (usually to dissolve the excess carboxylic acid) and then a small amount of acetone (to remove the extra carboxylic acid). The material was then dried in air for overnight and redissolved in small amount of acetone.

Table 7 lists the average size of the core of the eight thiol-capped gold nanoparticles and the closest distances between nanoparticles (core edge to core edge distance) obtained from the TEM images of an evaporated dilute solution of the particles. As shown in Table 7, the nanoparticle core sizes of the alkanethiol capped gold nanocrystals were 3±1 nm except for the Au—S—CPhOC nanoparticles that were larger (˜8 nm). The resistance of the thin film formed from pure thiol capped gold nanocrystals is a function of the electron tunneling between the metallic cores. The electronic conductivity, σ, of the alkanethiol capped gold nanocrystals can be related to the rate constant for electron transfer between metal nanoparticles separated by a dielectric medium. The electronic conductivity has been shown to be given by:

$$σ ∝ {k}_{et} ∝ {ⅇ}^{- δβ} {ⅇ}^{- \frac{{E}_{c}}{{k}_{B} T}} \qquad ( 7 )$$

where δ is the core-to-core separation of the nanocrystals, β is a constant typically of the order of 1 Å⁻¹, E_{c} is the activation energy for transfer of an electron between two metal particles, k_{B} is the Boltzmann constant and T is the absolute temperature. Thus, the film resistance was expected to change dramatically with the chain length of the thiol capping groups. As shown in Table 7, on going from C₃ to C₁₆ caps the core-to-core distance increased by ≈1.6 nm consistent with an increase in the chain length of 13 bonds. The pure Au—S—C₈ nanoparticle film had a typical resistance of ˜50 kΩ on interdigitized electrodes (IDEs) (10 μm gap, film thickness of ≈1 μm), while the resistance of Au—S—C₁₂ and Au—S—C₁₆ films were greater than could be measure (>1 GΩ) even for film thickness >10 μm on the IDEs. Thus, the conductivities of the films varied from 10⁻³ to >10⁻⁹ Ω⁻¹ cm⁻¹ in going from the C₃ to the C₁₆ capping group. Due to the high resistances of the pure alkanethiol capped gold nanocrystal films, 10% weight of carbon black was added to the solutions of these nanoparticles prior to casting of the sensor films onto the 0.8 mm gap substrates to lower their resistance. The current-voltage (I-V) characteristics were obtained for all films at room temperature in the range of −3 V to 3 V. All films displayed ohmic behavior in this voltage range.

TABLE 7
Core sizes (d) of the gold nano-clusters and the nearest distances (d)
between the core and core (edge to edge distance) measured from the
TEM images. The distance of the sample of Au—S—CPHOC was
not listed because the particles in this sample is highly aggregated.

| | d/mm | δnm |
|---|---|---|
| Au—S—C₃ | 3.3 ± 0.7 | 1.2 ± 0.4 |
| Au—S—C₆ | 1.8 ± 0.4 | 1.5 ± 0.5 |
| Au—S—_{c8} | 2.7 ± 0.5 | 1.7 ± 0.6 |
| Au—S—C₁₂ | 2.9 ± 0.7 | 1.9 ± 0.5 |
| Au—S—C₁₆ | 3.0 ± 0.8 | 2.8 ± 0.5 |
| Au—S—C₂PH | 3.3 ± 0.6 | 1.5 ± 0.9 |
| Au—S—C₆OH | 2.3 ± 0.4 | 1.6 ± 0.5 |
| Au—S—CPHOC | 8.5 ± 2.2 | — |

Substrates and Detector Films. Sensors were cast from gold nanoparticle solutions or TiO₂ colloid suspensions with 10% carbon black conducting composites (mass ratio) added and sonicated for >30 minutes at room temperature. Detector substrates were fabricated by evaporating 300 nm of chromium and 700 nm of gold onto glass microscope slides using 0.8-mm-wide drafting tape as a mask. After evaporation, the mask was removed and the glass slides were cut into 10 mm×25 mm pieces. The 0.8 mm gap region was then drop cast with the prepared suspension (usually one drop was sufficient since the solutions were nearly saturated).

Typically 3 to 6 vapor detectors were prepared at a time, and the detectors were placed in a row in a small linear chamber constructed of aluminum and Teflon. The internal cross-sectional area of the chamber was approximately 1 cm². The dc resistance of each sensor was measured with a multiplexing digital multimeter (Model HP 34970a, Hewlett Packard) using short twisted-pair connections and integration times that spanned at least two power line cycles.

Measurements. A computer-controlled automated flow system was used to deliver controlled pulses of a diluted stream of solvent vapor to the detectors. The instrumentation and apparatus for resistance measurements and for delivery of analyte vapors is described herein. Oil-free air was obtained from the house compressed air source (1.10±0.15 parts per thousand (ppth) of water vapor) controlled with a 28 L min⁻¹ mass flow controller (UNIT).

To initiate an experiment, the detectors were placed into a flow chamber and an air flow of 5 L min⁻¹ (1.10±0.15 parts per thousand (ppth) of water vapor) was introduced until the resistance of the detectors stabilized. An individual analyte exposure to the detectors consisted of a three-step process that was initiated with 70 s of airflow to achieve a smooth baseline resistance. Then analyte vapor at a controlled concentration in flowing air was introduced to the detectors for 80 s, followed by 60 s of airflow to restore the baseline resistance value for most analytes vapors.

For the experiments described here, eight analytes were used: five nonpolar hydrocarbons (cyclohexane, n-hexane, n-heptane, n-octane, and isooctane), tetrahydrofuran (THF), ethanol and ethyl acetate. These eight analytes were presented in random order 200 times each to the detector array during a single run over 4 days. All analytes were presented to the detector array at concentrations of approximately P/P^{o}=0.005 (P^{o} is the room temperature vapor pressure of the analyte) except for the dose response study. The dose response study was performed in a separate experiment where the analytes were presented to the detector array with concentrations varying from 0.003-0.2 P/P^{o}.

Data Pre-Processing. The response of a vapor detector to a particular analyte was expressed as ΔR/R_{b}, where R_{b} is the baseline resistance of the detector in the absence of analyte, and ΔR is the baseline-corrected steady-state resistance change upon exposure of the detector to analyte. ΔR/R was used instead of ΔR because it has been found in prior studies to be more a reproducible metric. Additionally, baseline correction was performed by fitting a spline to the data obtained during the pre-exposure period, and subtracting the spline over the entire exposure.

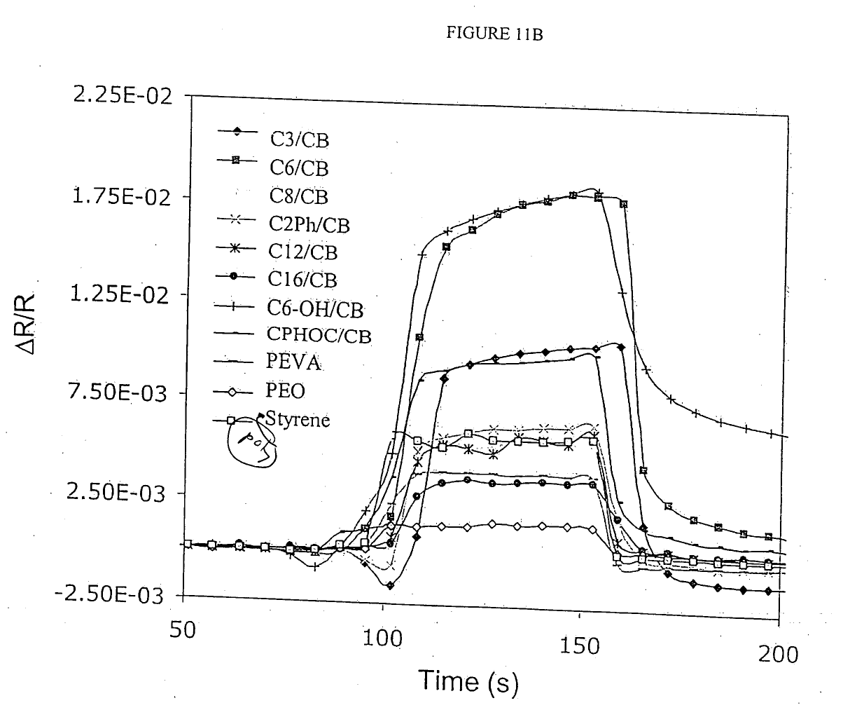

FIG. 11 (A) and (B) shows the response of several typical capped gold colloid-carbon black sensors upon exposure to n-hexane and ethanol vapor at a concentration of 0.005 P/P^{o}, respectively. Both the system response time and the recovery time are on the order of seconds. After exposure to the analyte the sensor's resistance returned to the pre-exposure baseline. All of the sensors tested showed increases in resistance when exposed to n-hexane. In general sorption sensors show increases in resistance with increasing expose to an analyte. This increase in resistance is normally ascribed to a decrease of the numbers of the carbon black pathways due to the swelling of the sensor film arising from the analyte absorption.

In addition, Au—S—C₁₂ and Au—S—C₁₆ nanocrystals mixed with carbon black were deposited on both IDEs with 10 μm and on substrates with 0.8 mm gaps. No significant changes in the sensor sensitivity, response time or stability for the two substrates were observed.

The resistance responses of the eight types of alkanethiol capped gold nanocrystals-carbon black sensors to the eight analytes at 0.005 P/P^{o} tested in the experiments were listed in the Table 8. For comparison, the resistance responses to the eight analytes of three typical polymer-carbon black (with 20% weight of carbon black) sensors, PEVA (poly(ethylene-co-vinyl acetate, 82% ethylene)), PEO (polyethylene oxide) and polystyrene, are also listed in the Table 8. The data in parentheses are the standard deviations of the sensor response for 200 exposures to each analyte. From this table, it is interesting to notice that most capped gold colloid-carbon black sensors showed higher responses (as high as 5 to 10 times in magnitude) compared to typical non-conductive polymer-carbon black sensors. This makes the alkanethiol capped gold nanocrystals-carbon black sensors very attractive for applications. The preparation of the gold nanocrystals only involves simple wet chemistry and the addition of the carbon black makes the sensors useful with normal electrodes having large gaps between the contacts, while the sensors show much higher responses than typical polymer-carbon black composite sensors.

TABLE 8
The resistance changes, ΔR/R_{b} × 1000, of the eight type functionalized capped
gold nanoparticle - carbon black films to the eight analytes tested at
0.005 P/P^{o}. The data in parentheses are the standard deviations of the
sensor responses upon 200 exposures to any analyte. The responses of three
polymer-carbon black composite sensors are also listed for comparison.

| | C3/CB | C6/CB | C8/CB | C2ph/CB | C12/CB | C16/CB | C6OH/CB | CPHOC/CB | PEVA | PEO | Polystyrene |
|---|---|---|---|---|---|---|---|---|---|---|---|
| N-hexane | 12.28 | 16.32 | 5.53 | 7.24 | 5.74 | 3.57 | 13.56 | 8.02 | 3.90 | 1.39 | 5.50 |
| | (1.16) | (4.28) | (0.41) | (0.79) | (0.48) | (0.33) | (2.37) | (3.18) | (0.31) | (0.16) | (0.56) |
| THF | 5.33 | 6.54 | 3.07 | 3.68 | 3.08 | 2.22 | 17.23 | 4.74 | 4.71 | 2.80 | 5.66 |
| | (0.95) | (2.23) | (0.51) | (0.67) | (0.59) | (0.41) | (4.34) | (2.47) | (1.01) | (0.61) | (1.33) |
| Ethanol | 1.27 | 1.25 | 0.37 | 0.65 | 0.34 | 0.27 | 9.65 | 1.32 | 0.76 | 1.39 | 0.43 |
| | (0.62) | (0.85) | (0.05) | (0.29) | (0.12) | (0.10) | (1.46) | (0.70) | (0.10) | (0.15) | (0.13) |
| Ethyl acetate | 7.65 | 6.30 | 1.96 | 5.57 | 2.09 | 1.42 | 17.01 | 5.88 | 3.80 | 3.01 | 3.92 |
| | (0.89) | (2.47) | (0.21) | (0.71) | (0.33) | (0.20) | (3.59) | (2.80) | (0.67) | (0.58) | (0.80) |
| cyclohexane | 5.91 | 11.14 | 5.41 | 3.58 | 4.91 | 3.40 | 9.01 | 4.96 | 4.81 | 1.23 | 6.37 |
| | (1.57) | (2.73) | (0.47) | (0.87) | (0.60) | (0.37) | (1.56) | (2.39) | (0.66) | (0.27) | (1.38) |
| N-heptane | 15.71 | 18.59 | 5.40 | 9.19 | 5.96 | 3.63 | 15.20 | 8.54 | 3.01 | 1.22 | 4.17 |
| | (0.98) | (5.60) | (0.63) | (0.72) | (0.73) | (0.36) | (2.93) | (4.28) | (0.49) | (0.25) | (0.90) |
| N-octane | 20.67 | 23.58 | 6.10 | 12.28 | 7.05 | 4.27 | 17.67 | 10.76 | 2.95 | 1.41 | 4.13 |
| | (0.88) | (6.03) | (0.69) | (0.58) | (0.97) | (0.44) | (2.67) | (4.76) | (0.53) | (0.28) | (0.90) |
| Iso-octane | 18.80 | 21.85 | 6.49 | 12.09 | 6.09 | 3.61 | 12.62 | 9.17 | 3.57 | 1.09 | 4.36 |
| | (1.15) | (5.16) | (0.79) | (0.99) | (1.04) | (0.47) | (2.19) | (4.00) | (0.58) | (0.22) | (0.95) |

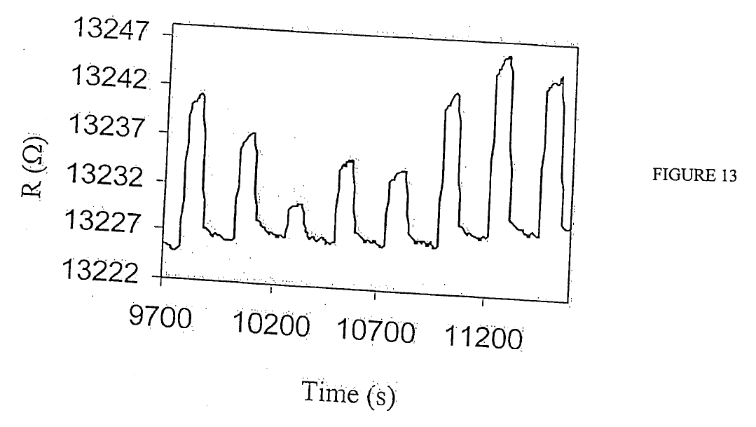

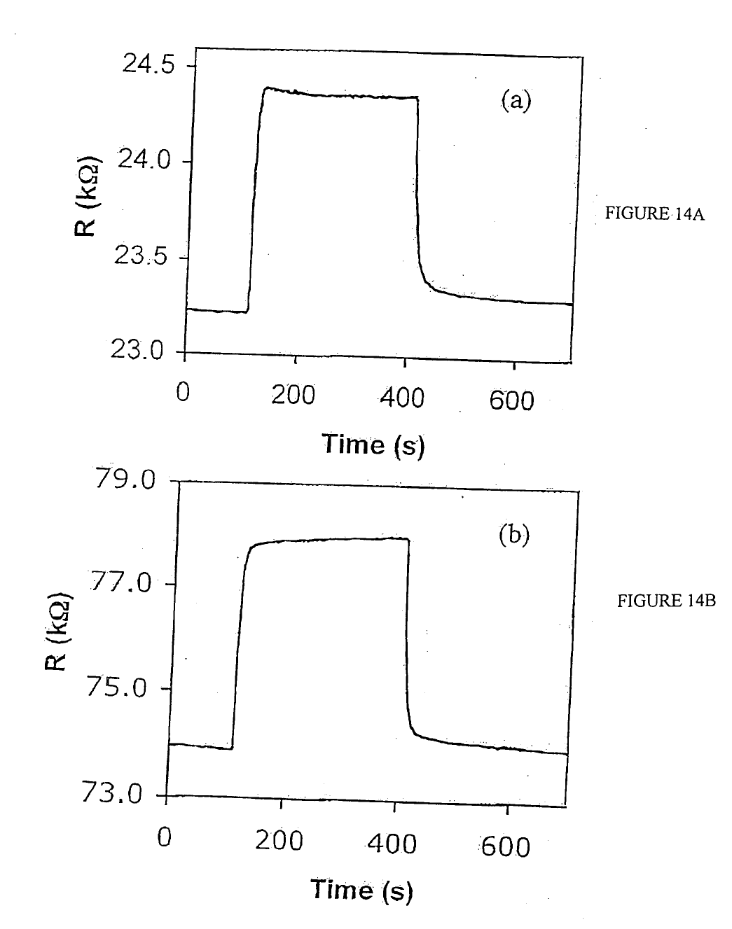

FIG. 13 shows the resistance response of the C₁₅COOH capped TiO₂ colloid-carbon black composite sensors to the eight analytes tested, i.e., hexane, ethanol, THF, ethyl acetate, cyclohexane, heptane, octane, i-octane. The sensors were pre-exposed to clean lab air for 70 seconds, then were exposed to hexane at 0.005 P/P^{o} for 60 seconds, then post-exposed to air for another 80 seconds. Then the process was repeated with the analyte change from hexane to ethanol, then to THF, etc until all the eight analytes were tested. From FIG. 14, both the response time and recovery time of the TiO₂—Cl₆/carbon black sensor are at the order of seconds. The sensor showed an increase in the resistance reading during exposure of the analytes ascribed to the decreasing of the carbon black pathways in the film arising from the swelling of the film due to the vapor absorption of the film. The ΔR/R responses of this TiO₂—Cl₆/carbon black sensor to hexane, ethanol, THF, ethyl acetate, cyclohexane, heptane, octane and i-octane are 0.0012, 0.0009, 0.0004, 0.0008, 0.0007 0.0013, 0.0016, and 0.0015, respectively. Table 9 list the resistance response of the six types of carboxylic acid capped TiO₂ colloids to the analytes tested at 0.005 P/P^{o}. Comparing to Table 8, carboxylic capped TiO₂ show much less responses than that of alkanethiol capped gold nanocrystals though still comparable response to those of the polymer-carbon black sensors. This is believed due to the larger particle sizes of TiO₂ colloids. TEM images have been taken on the TiO₂ particles and all particles show size larger than 5 nm with a lot of aggregation observed in the samples.

TABLE 9
The resistance changes, ΔR/R_{b} × 1000, of the six type functionalized TiO₂
nanoparticles - carbon black films to the seven analytes tested at 0.005 P/P^{o}.
The data in the parentheses are the standard deviation of the sensor
response upon 200 exposures.

| | TiO₂—C₈ | TiO₂—C₁₂ | TiO₂—C₁₆ | TiO₂—C₂₄ | TiO₂—C₁₂Br | TiO₂—C₄C═CC₆ |
|---|---|---|---|---|---|---|
| N-hexane | 2.74 (1.75) | 1.69 (0.66) | 1.23 (0.05) | 0.52 (0.06) | 1.17 (0.37) | 1.60 (0.55) |
| Ethanol | 0.32 (0.45) | 0.84 (0.54) | 0.24 (0.03) | 0.18 (0.06) | 2.77 (1.15) | 0.84 (0.54) |
| Ethyl acetate | 0.84 (0.97) | 1.09 (0.57) | 0.61 (0.04) | 0.33 (0.05) | 1.31 (0.39) | 1.00 (0.52) |
| cyclohexane | 0.53 (1.92) | 0.92 (0.48) | 0.56 (0.03) | 0.34 (0.05) | 0.81 (0.20) | 1.11 (0.50) |
| N-heptane | 3.96 (1.66) | 2.22 (0.84) | 1.15 (0.04) | 0.61 (0.07) | 1.33 (0.40) | 1.96 (0.61) |
| N-octane | 5.06 (1.88) | 2.59 (1.06) | 1.41 (0.05) | 0.66 (0.08) | 1.43 (0.54) | 2.25 (0.67) |
| Iso-octane | 3.03 (2.38) | 2.07 (0.82) | 1.22 (0.04) | 0.55 (0.06) | 1.38 (0.43) | 1.98 (0.62) |

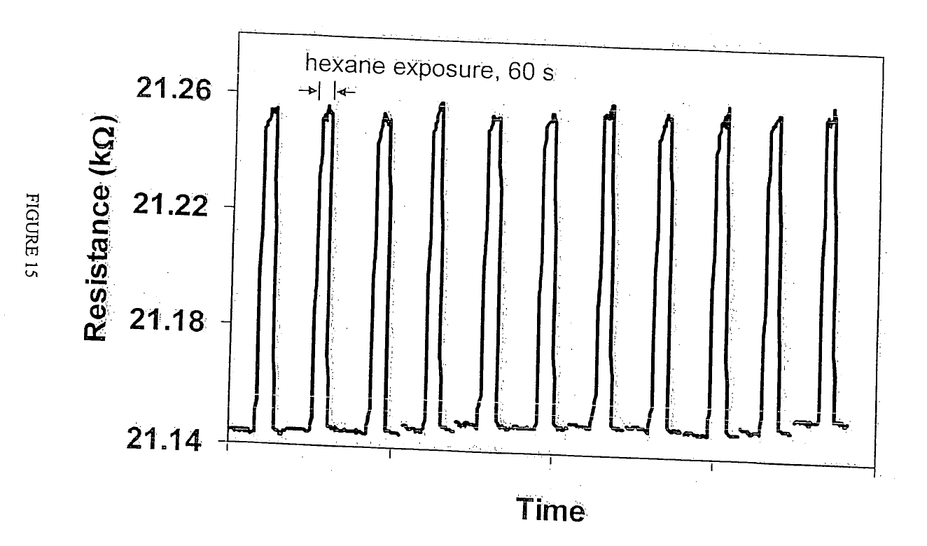

Sensor reproducibility and stability. FIG. 15 shows a typical resistance change of a gold nanocrystals-carbon black composite (here, Au—S—C₂Ph) upon eleven cycles of hexane exposure at 0.005 P/P^{o} in air. The eleven cycles were extracted sequentially from the 1600 exposures of randomly sampled seven analytes. For example, the second cycle shown in FIG. 15 was ˜3000 s after the first cycle shown while the third was ˜1500 s after the second one. There were 10 exposures to the other 6 analytes exposure between the first and second exposures. The resistor responses in shown FIG. 15 fully returned to their baseline values after analyte exposure indicating that the resistance increase was due to reversible physical swelling.

For all analytes and the gold nanocrystals-carbon black sensors tested (Table 8), the average standard deviation of the sensor to the analytes over the 1600 exposures is <23% of the magnitude of the corresponding response. Part of the observed deviation in sensitivity arises from variation in the room temperature. A 1° C. change in room temperature would cause a 6% change in the vapor pressure of ethanol (P^{o} of ethanol at 20, 21 and 22° C. are 44, 47, and 50 torr, respectively). No baseline or sensitivity drift was observed over a period of four days and 1600 exposures. In a separate study, a shelf life of more than a month has been demonstrated for the sensors.

Similar experiments were also performed on TiO₂ colloids -carbon black sensors and polymer-carbon black sensors showed an average response standard deviation of 43% and 41%, respectively.

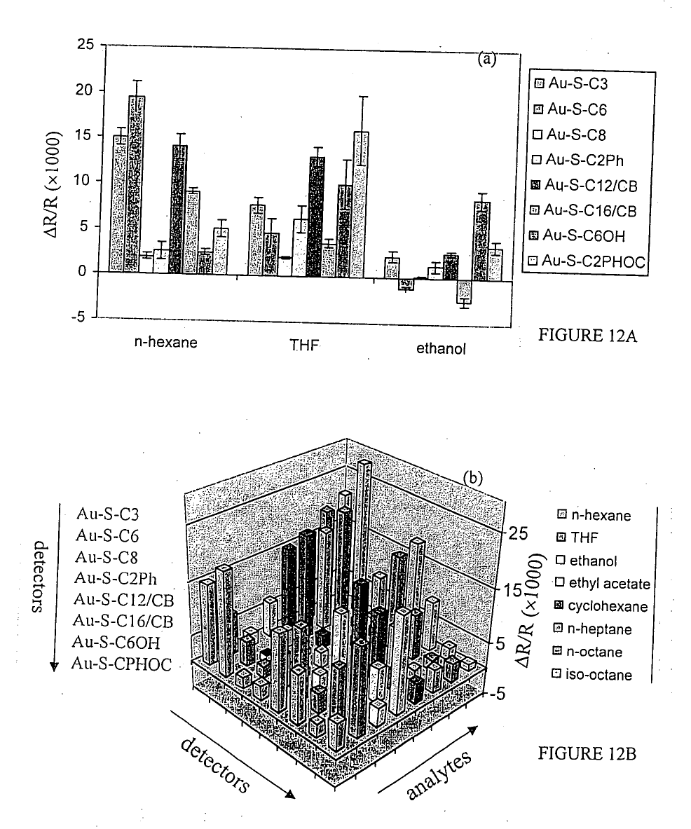

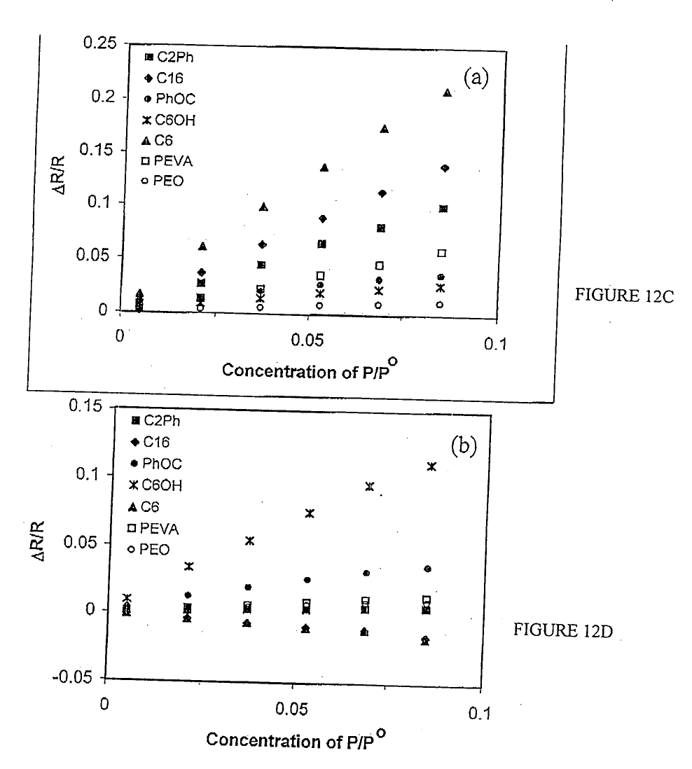

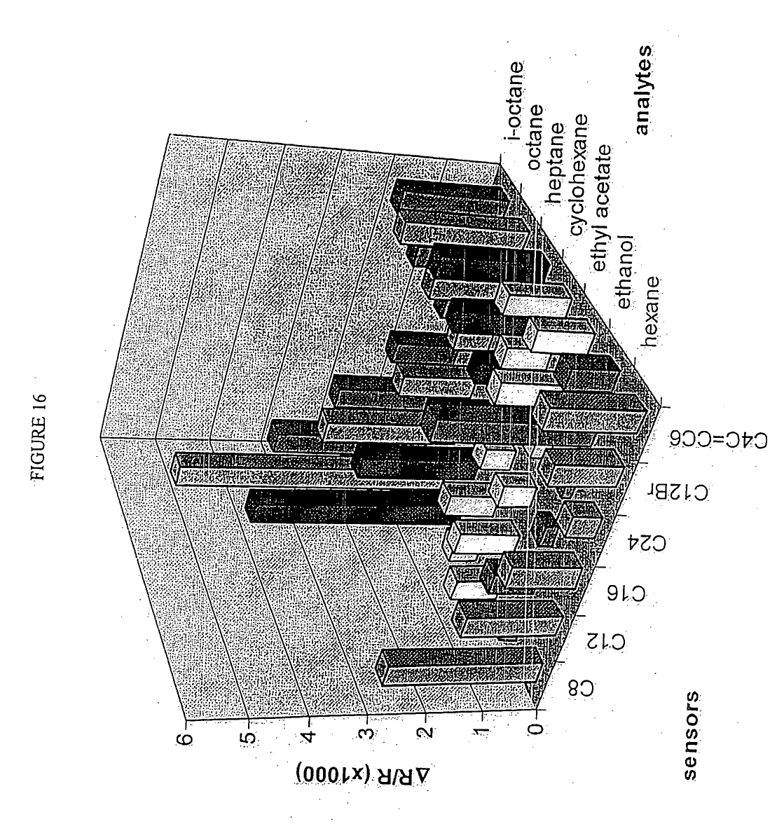

Response of the sensors to the analytes could be tuned by changes in the capped organic ligand function groups and lengths. In this way, sensor array could be easily reached with the variation of the capping ligands. The 3-D pattern of the sensor array made from the eight alkanethiol capped gold nanocrystals-carbon black sensors and the six types carboxylic acid capped TiO₂ colloids-carbon black sensors to the analytes tested at a concentration of 0.005 P/P^{o} are shown in FIGS. 12 and 16, respectively. Visual inspection of the data in the figures reveals qualitative differences in detector fingerprints for these solvents demonstrating the ability of these arrays to distinguish these vapors.

### Example 4

### Carbon Black-Non-Polymeric Organic Insulator Sensors

This example describes the properties of chemiresistive vapor sensors that are comprised of composites of conductive material (e.g., carbon black particles) and an insulating non-polymeric organic material, wherein the sorption phase consists of simple, monomeric, low vapor pressure organic materials. Such sorption films have a relatively high density of functional groups and thereby provide effective sorption of organic analyte vapors. The random arrangement of the organic molecules in the sorption phase produce rapid vapor permeability and therefore rapid sensor response times, and produce reversible responses that show relatively little history efforts or hysteresis in response to a wide range of organic analyte vapors. The use of non-polymeric materials opens up a wide range of sorption phases having desirable chemical functionality and physical properties that are not readily accessible in the form of polymeric materials.

Materials. The insulating materials used in fabricating the sensor films (Scheme II) and the plasticizer dioctyl phthlate were used as received from either Aldrich Chemical Co. or Acros Organics Co. Reagent grade toluene, n-hexane, tetrahydrofuran (THF), ethanol, ethyl acetate, cyclohexane, heptane, octane, isooctane and were used as received from Aldrich Chemical Co. Black Pearls 2000 (BP 2000), a furnace carbon black material, was donated by Carbot Co. (Billerica, Mass.) and was used as received.

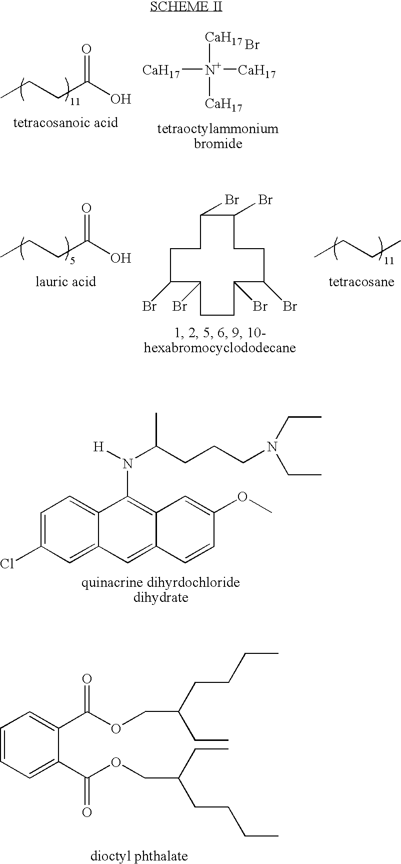

Detectors. Detector substrates were fabricated by evaporating 300 nm of chromium and 700 nm of gold onto glass microscope slides using 0.8-mm-wide drafting tape as a mask. After evaporation, the mask was removed and the glass slides were cut into 10 mm×25 mm pieces.

Sensor films consisted of suspensions of various amounts of carbon black and either pure or mixtures of organic material cast in 20 mL of either toluene or THF. Table 10 details the fabrication of each sensor, listing sensor number and respective constituent materials. Prior to fabrication of the detector films, the casting suspension was sonicated for >30 min at room temperature. Films were made by spraying these suspensions across the 0.8 mm gap with an airbrush (Koscho, Grubbs et al. 2002) onto detector substrates until the initial resistance between the two leads was 10-100 kΩ.

TABLE 10A-B
(a)

| | | amount (mg) | | |
|---|---|---|---|---|
| sensor # | Sorption material | sorption | plasticizer | CB |
| 1. | tetraoctylammonium bromide/ | 80 | 80 | 20 |
| | dioctyl phthalate | | | |
| 2. | Lauric acid/dioctyl phthalate | 80 | 72 | 21.3 |
| 3. | tetracosane acid | 80 | 0 | 26 |
| 4. | Tetracosane acid/dioctyl phthalate | 80 | 50 | 21.5 |
| 5. | tetracosane/dioctyl phthalate | 100 | 60 | 40 |
| 6. | propyl gallate | 160 | 0 | 40 |
| 7. | 1,2,5,6,9,10- | 100 | 60 | 40 |
| | hexabromocyclododecane/ | | | |
| | dioctyl phthalate | | | |
| 8. | quinacrine dihydrochloride | 160 | 0 | 40 |
| | dihydrate | | | |
| 9. | quinacrine dihydrochloride | 100 | 60 | 40 |
| | dihydrate/dioctyl phthalate | | | |

(b)

| sensor | sorption material |
|---|---|
| 1 | Polycaprolactone |
| 2 | poly(ethylene-co-vinyl acetate) |
| 3 | poly(ethylene oxide) |
| 4 | poly(ethylene glycol) |
| 5 | poly(methyl vinyl ether-co-maleic anhydride) |
| 6 | poly(4-vinyl phenol) |
| 7 | Polycarbonate |
| 8 | poly(vinyl butyral) |
| 9 | Polystyrene |

(a) Sorption material used in carbon black - non polymer composite sensors. Plasticizer denotes amount of dioctyl phthalate. 20 ml of either THF or toluene was added to sorption and plasticizer materials, followed by addition of carbon black (CB); followed by sonication for >30 minutes.
(b) Sorption material used in carbon black - polymer composite sensors from previously reported results (Sisk and Lewis 2005), fabricated with 40% of listed sorption material, 40% di(ethylene glycol) dibenzoate (plasticizer), and 20% carbon black.

Measurements. To initiate an experiment, the detectors were placed into a flow chamber and an air flow of 5 L min-1 containing 1.10±0.15 parts per thousand (ppth) of water vapor was introduced until the resistance of the detectors stabilized. An individual analyte exposure to the detectors consisted of a three-step process that was initiated with 70 s of airflow to achieve a smooth baseline resistance. Analyte vapor at a controlled concentration in flowing air was then introduced to the detectors for 80 s, followed by 60 s of airflow to restore the baseline resistance value.

Analytes consisted of five nonpolar hydrocarbons (cyclohexane, n-hexane, n-heptane, n-octane, and isooctane) as well as ethanol and ethyl acetate. In the first set of data collection, these seven analytes were presented in random order 200 times each to the detector array during a single run over 4 days. Subsequent runs which were identical in their randomized analyte exposure order, exposure times and protocols were performed to assess the long term drift and stability of the sensors. The second run was initiated 2 days after the completion of the first run; the third run was initiated 2 days after the completion of the second run, and the fourth run was initiated 6 months after the completion of the third run. All analytes were presented to the detector array at concentrations corresponding to P/P^{o}=0.0050, where P is the partial pressure and P^{o} is the vapor pressure of the analyte at room temperature. In a separate run to evaluate the concentration dependence of the sensor response, done 3 weeks after the fourth and final set of exposures at P/P^{o}=0.0050 (˜7 months after initial run), concentrations of hexane and ethanol were varied at ten different intervals of P/P^{o} within the range 0.002<P/P^{o}<0.07. Sensors were first exposed to hexane at the ten chosen values of P/P^{o} in randomized order. For each exposure, 100 seconds of laboratory air was run through the system at 5 l/min, followed by 100 seconds of exposure at 5 l/min total flow and at the given saturation pressure, followed by 100 seconds of laboratory air as a purge. This sequence was then repeated four times, for a total of five randomized exposures to each chosen saturation pressure. This same procedure was then used for ethanol.

Data Processing. The response of a sensor to a particular analyte was expressed as ΔR/R_{b}, where R_{b} is the baseline resistance of the sensor (after correcting for baseline drift) and ΔR is the steady-state resistance change upon exposing the sensor to analyte, defined as Rₘₐₓ-R_{b}. The ratiometric quantity ΔR/R_{b} was used as the response descriptor because it is both relatively insensitive to vapor introduction technique and to increase linearly with analyte saturation pressure. R_{b} was calculated by averaging over 5 resistance measurements before the exposure initiated, and Rₘₐₓ was calculated by averaging over at least 3 consecutive resistance measurements (in most cases 4 or 5) such that an equilibrium response was assured to have taken place. All data processing was performed using Matlab (The Mathworks, Natick, Mass.). Note that the frequency of resistance measurements provided each sensor with a reading approximately every 7 seconds, so by averaging over 3-5 points a 20-35 second average is achieved.

Quantification Of Classification Performance. For quantification of classification, the responses from each of the datasets were sum-normalized to remove any inconsistencies in the vapor delivery system. Owing to the detectors linear response with respect to analyte concentration, this sum-normalized signal is invariable with respect to analyte delivery inconsistencies and provides a characteristic fingerprint for each analyte. This process was performed using eq 8:

$${S}_{ij}^{′} = \frac{{S}_{ij}}{{\sum }_{j = 1}^{n} {S}_{ij}} \qquad ( 8 )$$

where Sᵢⱼ refers to the ΔR/Rb sensor response signal of the jth detector (out of n total detectors) to the ith analyte exposure, and S′ᵢⱼ represents the sum-normalized analog of Sᵢⱼ.

The Fisher Linear Discriminant (FLD) algorithm was used on sum-normalized sensor response data to analyze the classification performance of the sensors. In the FLD approach, sensor responses of a training set are used to calculate a vector that projects response data onto the one-dimensional space which maximizes separations between the two sets of data clusters. For normalized data (eq 8) produced by the responses of an n-detector array, this projection has the form:

$${D}_{i} = {\sum }_{j = 1}^{n - 1} {c}_{j} {S}_{ij}^{′} \qquad ( 9 )$$

where cⱼ represents one of the n−1 weighting factors from the hyperplane determined by the FLD algorithm. The value of Dᵢ (hereafter referred to as the D-value) is a single, scalar metric that characterizes the position, along a vector normal to some hyperplane decision boundary, of the detector array data produced by an individual analyte exposure. The chosen hyperplane decision boundary is defined as the point in one-dimensional projected space for which a data point lying on this plane has equal chance of belonging to either of the two data clusters.

The FLD algorithm maximizes the separation, or clustering, of the two distinct populations of D-values that arise from a single binary separation task. This clustering is measured by the resolution factor (rf) characteristic of a separation task, as given in eq. 10:

$$rf = \frac{δ}{{( {σ}_{1}^{2} + {σ}_{2}^{2} )}^{0.5}} \qquad ( 10 )$$

Here, δ is the difference in the population means of D-values, and σ1 and σ2 are the standard deviations of the two populations of D-values that correspond to the two analytes of the separation task. The FLD algorithm was used to evaluate the separation of two analytes at a time for each possible pairwise combination of analytes in the data set.

Because a supervised algorithm inherently introduces some bias into the analysis, a train/test scheme was employed. For each pair of analytes that comprised a single separation task, the first 100 exposures to each analyte (exposures 1-100, data set 1) were used to generate a training set and a set of coefficients (comprising a classification model) as described in eq. 9. A decision boundary was then developed by defining the hyperplane at which an unknown analyte exposure would have an equal probability (according to eq. 10) of belonging to either analyte population of the given binary separation task. All subsequent data were treated as test data, in that the Fisher algorithm was not performed after the training phase, and analyte identities were classified according to their positions relative to the fixed FLD decision boundary.

Of importance in signal processing is a measure of signal strength, measured by a signal to noise ratio (SNR). This was calculated as follows:

$$SNR = \frac{Δ R}{3 {σ}_{baseline}} \qquad ( 11 )$$

where ΔR is as previously described, and σ_{baseline} represents the standard deviation in baseline resistance before analyte delivery, calculated using at least 5 data points.

Carbon black-polymer composite chemiresistor data previously recorded and reported above for exposure to analytes at the same saturation of has been analyzed in the same manner as the sensors under study, and is given for comparison. Specifically, resolution factors are given for both sensor types for a baseline measure of resolving ability, and signal to noise ratios are given for both sensor types to determine relative strength of signal.

To examine more closely reported differences in SNR between these two sensor classes, sensor responses (ΔR/Rb) were listed additionally for carbon black-non polymeric sensors (table 11.b), as was a measure of baseline noise for each sensor class (table 13). Noise was defined as in the denominator of SNR (eq 11), specifically:
noise=3σ_{baseline} (12)

With these additions, differences between the two sensor classes with respect to SNR can be attributed to differences in either signal or noise levels, or a combination of the two.

TABLE 11
(a) Sensor response, ΔR/R_{b} (×1000), of carbon black - non polymer composite
sensors to seven test analytes presented at a concentration of P/P^{o} = 0.0050.
See table 10.a for sensor descriptions. (b) Sensor response, ΔR/R_{b}
(×1000), of carbon black - polymer composite sensors to seven test analytes
presented at a concentration of P/P^{o} = 0.0050. Sensors were subject to 200
exposures to each analyte selected from 1400 randomly ordered exposures to
seven analytes; means and standard deviations for each sensor to each
analyte are listed.

| | | | | | | | | |
|---|---|---|---|---|---|---|---|---|
| | | n- | | ethyl | c- | n- | n- | i- |
| sensor | ΔRₘₐₓ/R_{b} (×1000) | hexane | ethanol | acetate | hexane | heptane | octane | octane |

(a)

| | | | | | | | | |
|---|---|---|---|---|---|---|---|---|
| 1 | Mean | 5.77 | 2.63 | 6.33 | 6.77 | 5.36 | 5.36 | 6.02 |
| | standard deviation | 0.26 | 0.20 | 0.24 | 0.26 | 0.23 | 0.24 | 0.26 |
| 2 | Mean | 2.42 | 0.32 | 2.49 | 2.76 | 2.29 | 2.30 | 2.57 |
| | standard deviation | 0.20 | 0.17 | 0.20 | 0.21 | 0.20 | 0.18 | 0.20 |
| 3 | Mean | 1.43 | 0.29 | 0.74 | 0.71 | 1.53 | 1.70 | 0.64 |
| | standard deviation | 0.11 | 0.10 | 0.10 | 0.10 | 0.10 | 0.11 | 0.10 |
| 4 | Mean | 6.17 | 0.87 | 6.52 | 7.04 | 5.85 | 5.93 | 6.45 |
| | standard deviation | 0.24 | 0.19 | 0.21 | 0.25 | 0.22 | 0.21 | 0.23 |
| 5 | Mean | 1.37 | 0.20 | 0.97 | 1.47 | 1.31 | 1.35 | 1.43 |
| | standard deviation | 0.06 | 0.05 | 0.05 | 0.06 | 0.05 | 0.05 | 0.05 |
| 6 | Mean | 0.13 | 1.96 | 1.20 | 0.10 | 0.10 | 0.08 | 0.07 |
| | standard deviation | 0.04 | 0.17 | 0.10 | 0.05 | 0.04 | 0.05 | 0.05 |
| 7 | Mean | 1.00 | 0.22 | 0.88 | 1.09 | 0.93 | 0.95 | 0.92 |
| | standard deviation | 0.24 | 0.19 | 0.19 | 0.18 | 0.18 | 0.17 | 0.18 |
| 8 | Mean | 0.20 | 2.76 | 0.44 | 0.15 | 0.17 | 0.17 | 0.21 |
| | standard deviation | 0.15 | 0.42 | 0.24 | 0.43 | 0.10 | 0.19 | 0.25 |
| 9 | Mean | 0.25 | 0.56 | 0.24 | 0.21 | 0.21 | 0.22 | 0.32 |
| | standard deviation | 0.17 | 0.16 | 0.26 | 0.36 | 0.18 | 0.19 | 0.91 |

(b)

| | | | | | | | | |
|---|---|---|---|---|---|---|---|---|
| 1 | Mean | 0.32 | 0.61 | 1.33 | 0.49 | 0.28 | 0.28 | 0.33 |
| | standard deviation | 0.02 | 0.02 | 0.03 | 0.02 | 0.02 | 0.01 | 0.01 |
| 2 | Mean | 1.82 | 1.20 | 4.84 | 2.79 | 1.66 | 1.79 | 1.97 |
| | standard deviation | 0.05 | 0.05 | 0.13 | 0.06 | 0.05 | 0.04 | 0.05 |
| 3 | Mean | 0.42 | 0.32 | 0.58 | 0.56 | 0.42 | 0.47 | 0.52 |
| | standard deviation | 0.04 | 0.04 | 0.02 | 0.02 | 0.02 | 0.02 | 0.02 |
| 4 | Mean | 0.21 | 0.27 | 1.23 | 0.34 | 0.17 | 0.16 | 0.18 |
| | standard deviation | 0.02 | 0.02 | 0.04 | 0.02 | 0.02 | 0.02 | 0.02 |
| 5 | Mean | 2.02 | 0.66 | 3.78 | 3.10 | 1.85 | 2.01 | 2.24 |
| | standard deviation | 0.06 | 0.03 | 0.11 | 0.10 | 0.06 | 0.05 | 0.05 |
| 6 | Mean | 1.87 | 1.19 | 4.96 | 2.87 | 1.69 | 1.82 | 2.00 |
| | standard deviation | 0.06 | 0.05 | 0.19 | 0.11 | 0.06 | 0.05 | 0.05 |
| 7 | Mean | 1.47 | 0.75 | 5.53 | 2.38 | 1.29 | 1.35 | 1.45 |
| | standard deviation | 0.05 | 0.03 | 0.20 | 0.09 | 0.05 | 0.04 | 0.03 |
| 8 | Mean | 0.06 | 0.15 | 0.57 | 0.05 | 0.05 | 0.04 | 0.02 |
| | standard deviation | 0.01 | 0.01 | 0.02 | 0.01 | 0.01 | 0.01 | 0.01 |
| 9 | Mean | 0.68 | 1.22 | 3.46 | 0.61 | 0.57 | 0.52 | 0.23 |
| | standard deviation | 0.05 | 0.05 | 0.09 | 0.04 | 0.04 | 0.03 | 0.03 |

TABLE 12
(a) Signal to noise ratios (SNR) of carbon black - non polymer composite
sensors to seven test analytes presented at a concentration of P/P^{o} = 0.0050.
See table 10.a for sensor descriptions. (b) SNR of carbon black -
polymer composite sensors to seven test analytes presented at a
concentration of P/P^{o} = 0.0050. Sensors were subject to 200 exposures to
each analyte selected from 1400 randomly ordered exposures to seven
analytes; means and standard deviations for each sensor to each analyte are
listed.

| | | | | | | | | |
|---|---|---|---|---|---|---|---|---|
| | | n- | | ethyl | c- | n- | n- | i- |
| sensor | SNR | hexane | ethanol | acetate | hexane | heptane | octane | octane |

(a)

| | | | | | | | | |
|---|---|---|---|---|---|---|---|---|
| 1 | Mean | 41.3 | 16.7 | 43.1 | 49.7 | 38.5 | 37.9 | 43.8 |
| | standard deviation | 19.5 | 10.2 | 21.2 | 25.2 | 16.7 | 17.6 | 21.0 |
| 2 | Mean | 17.2 | 2.2 | 17.9 | 18.5 | 16.0 | 15.2 | 17.7 |
| | standard deviation | 8.6 | 1.4 | 9.0 | 9.6 | 7.9 | 6.9 | 9.1 |
| 3 | Mean | 14.6 | 3.3 | 7.6 | 7.5 | 16.4 | 16.8 | 6.5 |
| | standard deviation | 7.2 | 2.3 | 3.6 | 4.2 | 12.1 | 10.6 | 3.0 |
| 4 | Mean | 26.4 | 3.1 | 26.1 | 29.2 | 24.8 | 24.2 | 27.1 |
| | standard deviation | 17.4 | 2.0 | 25.6 | 17.7 | 18.2 | 15.2 | 18.5 |
| 5 | Mean | 28.7 | 4.2 | 21.0 | 30.4 | 27.7 | 27.4 | 30.9 |
| | standard deviation | 14.7 | 2.3 | 10.1 | 15.5 | 15.3 | 16.2 | 17.2 |
| 6 | Mean | 5.2 | 35.5 | 19.4 | 3.9 | 3.5 | 2.9 | 2.8 |
| | standard deviation | 3.7 | 18.0 | 6.2 | 2.9 | 2.3 | 1.9 | 2.0 |
| 7 | Mean | 5.4 | 1.1 | 4.9 | 6.0 | 5.4 | 5.2 | 5.4 |
| | standard deviation | 3.3 | 1.2 | 2.4 | 3.6 | 3.2 | 2.3 | 3.1 |
| 8 | Mean | 6.1 | 74.8 | 13.0 | 3.4 | 5.3 | 5.4 | 5.5 |
| | standard deviation | 3.2 | 41.1 | 8.0 | 2.0 | 2.9 | 3.3 | 2.8 |
| 9 | Mean | 5.2 | 12.1 | 4.9 | 4.5 | 4.9 | 4.3 | 5.9 |
| | standard deviation | 2.9 | 7.1 | 2.4 | 2.5 | 3.5 | 2.7 | 4.0 |

(b)

| | | | | | | | | |
|---|---|---|---|---|---|---|---|---|
| 1 | Mean | 34.0 | 34.1 | 168.2 | 71.5 | 44.5 | 46.0 | 47.7 |
| | standard deviation | 13.4 | 13.4 | 63.2 | 27.0 | 18.0 | 15.2 | 19.4 |
| 2 | Mean | 154.9 | 70.3 | 254.3 | 269.8 | 195.3 | 211.9 | 248.8 |
| | standard deviation | 76.4 | 33.9 | 62.3 | 92.0 | 73.2 | 79.9 | 104.2 |
| 3 | Mean | 10.5 | 9.9 | 35.5 | 20.2 | 13.0 | 14.3 | 18.8 |
| | standard deviation | 4.0 | 3.3 | 15.1 | 7.2 | 4.7 | 5.2 | 7.7 |
| 4 | Mean | 9.5 | 20.7 | 63.2 | 19.9 | 10.6 | 11.7 | 14.1 |
| | standard deviation | 3.9 | 7.6 | 29.1 | 7.2 | 3.6 | 4.8 | 6.8 |
| 5 | Mean | 34.5 | 17.7 | 64.2 | 60.6 | 44.4 | 48.5 | 66.1 |
| | standard deviation | 15.1 | 7.0 | 25.4 | 25.0 | 17.1 | 18.8 | 28.1 |
| 6 | Mean | 15.4 | 103.8 | 194.9 | 22.8 | 18.1 | 15.4 | 12.7 |
| | standard deviation | 7.0 | 41.3 | 92.7 | 10.7 | 6.6 | 6.1 | 4.9 |
| 7 | Mean | 79.4 | 48.6 | 451.7 | 175.3 | 98.2 | 101.4 | 106.7 |
| | standard deviation | 25.8 | 19.0 | 218.0 | 72.4 | 60.3 | 36.9 | 41.1 |
| 8 | Mean | 9.9 | 29.1 | 68.6 | 7.9 | 11.2 | 11.1 | 5.0 |
| | standard deviation | 4.0 | 12.7 | 26.8 | 2.8 | 4.9 | 4.3 | 2.6 |
| 9 | Mean | 21.8 | 18.0 | 108.5 | 16.4 | 25.5 | 23.2 | 9.6 |
| | standard deviation | 10.0 | 7.5 | 36.9 | 4.2 | 10.5 | 7.4 | 3.6 |

TABLE 13
Average baseline noise levels (ohms) of carbon black - non polymer
composite sensors and carbon black - polymer composite sensors.

| | sensor type | | | | | | | | |
|---|---|---|---|---|---|---|---|---|---|
| | 1 | 2 | 3 | 4 | 5 | 6 | 7 | 8 | 9 |
| non-polymer | 300.2 | 31.0 | 11.9 | 121.4 | 6.2 | 5.3 | 50.8 | 7.0 | 10.9 |
| polymer | 0.6 | 0.1 | 3.1 | 0.8 | 0.2 | 2.4 | 1.5 | 2.1 | 0.4 |

### Results

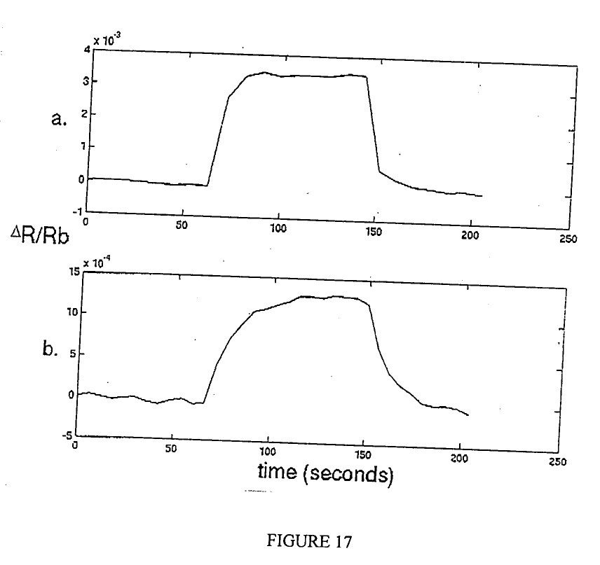

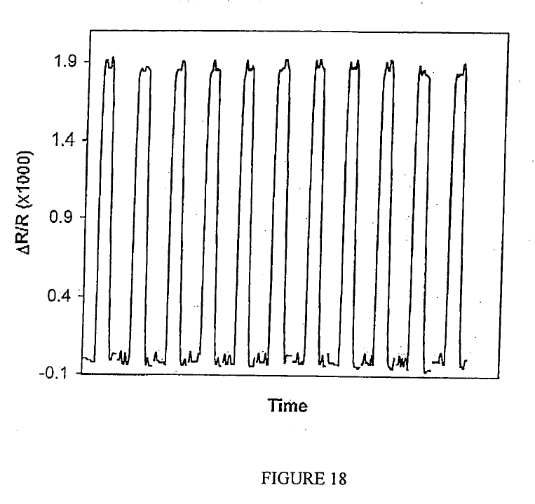

Vapor Response Characteristics. FIG. 17A shows the baseline-corrected resistance response of a typical carbon black-non-polymer composite sensor, quinacrine dihydrochloride dihydrate (sensor 8, table 10), during exposure ethanol at P/P^{o}=0.005. The resistance of all films increased when analyte vapor was present but rapidly (i.e., within seconds) returned to its original baseline resistance value after the vapor exposure had been discontinued. All sensors studied in this work exhibited behavior similar to that depicted in FIG. 17A. For comparison, a typical response of a 40% poly(vinyl butyrate), 40% dioctyl phthalate, 20% carbon black sensor to cyclohexane at P/P^{o}=0.005 is given in FIG. 17B.

Reproducibility. FIG. 18 shows a typical ΔR/Rb response of a carbon black-organic material, tetracosane/dioctyl phthalate composite film (sensor 5, table 10) during nine selected exposures to hexane at P/P^{o}=0.005 in air. The nine exposures depicted were selected from a single run that consisted of 1400 exposures to seven randomly sampled analytes. For example, the second cycle shown in FIG. 18 was ˜3000 s after the first depicted cycle, while the third cycle shown was ˜1500 s after the second depicted cycle. Ten exposures to the other 6 analytes existed between the first and second exposures to hexane depicted in this figure. As depicted in FIG. 18, the sensor responses fully returned to their baseline values after analyte exposure in all cases.

Table 11 presents the sensitivities and standard deviations of the responses measured for the 9 different sensor compositions exposed to the 7 analytes studied in this work at an activity of P/P^{o}=0.005 in air for the first set of data collection, with 200 randomly ordered exposures to each analyte. The sensitivities varied significantly across the analytes tested, and a given analyte produced different responses on different sensor films. For some of the non-polymeric composite sensors, namely sensors 1-5, the ratio of standard deviation of sensitivity to mean sensitivity (ΔR/Rb) is quite low (<0.1) indicating an extremely consistent response. In other cases, the ratio is quite large, indicating large variability in sensor response (sensors 6-9). Standard deviations of sensitivity for each sensor to all analytes is approximately the same across all sensors. Thus, the latter situation of large ratios of standard deviation to mean sensitivity is caused by a weaker sensitivity of the given sensor to each of the analytes presented.

Part of the observed variability in the response amplitude can be ascribed to the variation in room temperature during the exposures. For example, a 1° C. change in room temperature produces a 4.5% change in the vapor pressure of hexane (the vapor pressures of hexane at 20 and 21° C. are 119.9 and 125.3 torr, respectively). Negligible drift in the mean sensitivity or in the baseline resistance of the sensors was observed over the four day period during which the 1400 analyte exposures were performed.

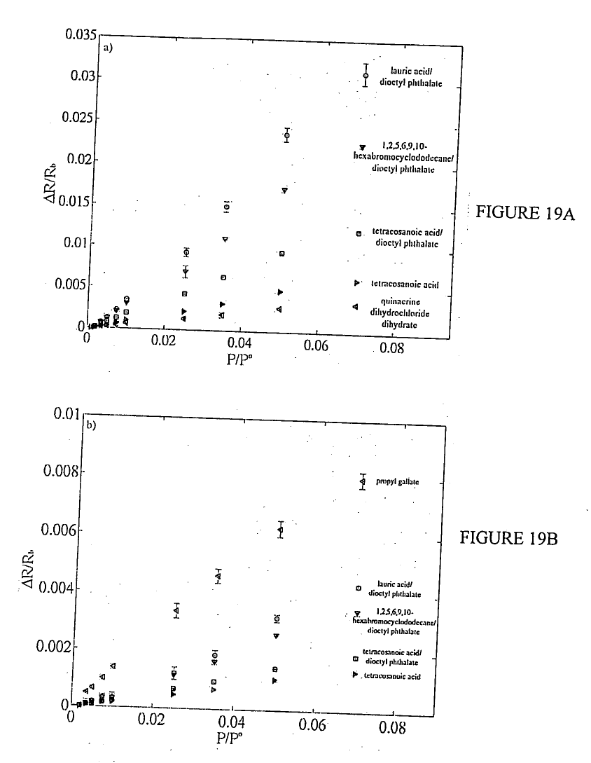

Concentration Dependence of Sensor Response. FIG. 19 displays dose-response curves for five typical monomer-carbon black composites as a function of the vapor phase concentration of hexane and ethanol, respectively. For the relatively low analyte concentrations used in this study, sensor responses were well-described by a linear dependence on P/P^{o}, indicating operation below the percolation threshold. This relationship has been observed for carbon black-polymer composite sensors operating below the percolation threshold.

Signal to noise ratios were calculated for each sensor on exposure to each of the analytes. Table 12a details the mean and standard deviations of SNRs for each sensor to the various analytes, calculated from the first set of data collection consisting of 200 exposures to each analyte in random orders of exposure. For comparison, table 12b gives SNRs of carbon black-polymer composite sensors on exposure to analytes at the same saturation vapor pressure of P/P^{o}=0.005. Tetraoctylammonium bromide/dioctyl phthalate (sensor 1) displays SNR on par with those listed for carbon black-polymer composite sensors, however most non-polymeric sensors display a SNR much lower than the listed polymeric sensors. On average, carbon black-polymer composite sensors exhibit much stronger signals compared to the carbon black-non polymer composites.

Limits of detection are listed in table 13 (a), based on dose-response data presented in FIG. 19. Signal to noise ratios were calculated (eq 11) for each of the sensors on exposure to hexane and ethanol at P/P^{o}=0.002, 0.0035, 0.005, 0.0075, 0.01, 0.0125, 0.025, 0.0375, 0.05, and 0.0625 and detection was taken to be the saturation pressure at which SNR>0.1. Limits of detection range from 0.002 to 0.0075, with most reported as either 0.0035 or 0.005 P/P^{o}. Meaningful conversions to concentrations, in parts per million (ppm), are given in table 13 (b) for each of the analytes at observed limits of detection. These values are on the same order of magnitude as those reported for carbon black-polymer composite sensors.

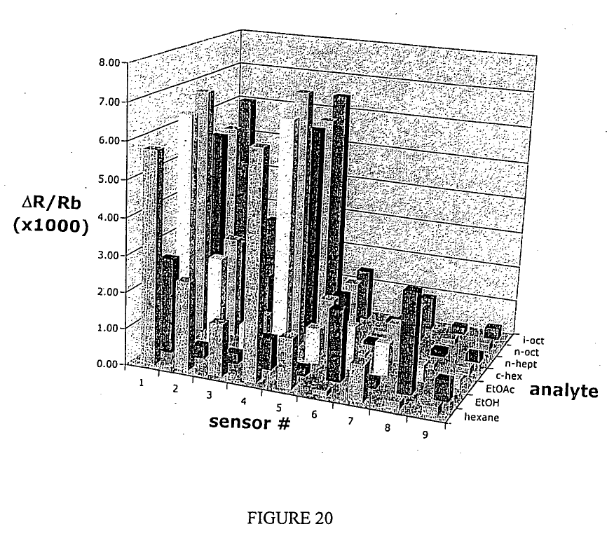

Sensor Specificity. FIG. 20 presents mean responses, averaged over 200 random exposures to each analyte (data set 1), for each of the composite films to the seven test analyte vapors at P/P^{o}=0.0050. Sensors are listed according to number, as given in table 10. Large differences in sensitivity were observed between the responses of a given sensor upon exposure to the various test analytes. The ratio of the ΔR/Rb responses to a prototypical polar analyte, ethanol, relative to the response to a prototypical nonpolar analyte, hexane, of the carbon black-propyl gallate (sensor 6, table 10) composite films was 20. In contrast, the carbon black-lauric acid/dioctyl phthalate sensor (sensor 2, table 10) exhibited a ratio of 0.1. The use of organic molecular sorption phases having a high-density of hydrophilic or hydrophobic functional groups can produce sensor arrays that display enhanced discrimination power between differing test pairs of analytes.

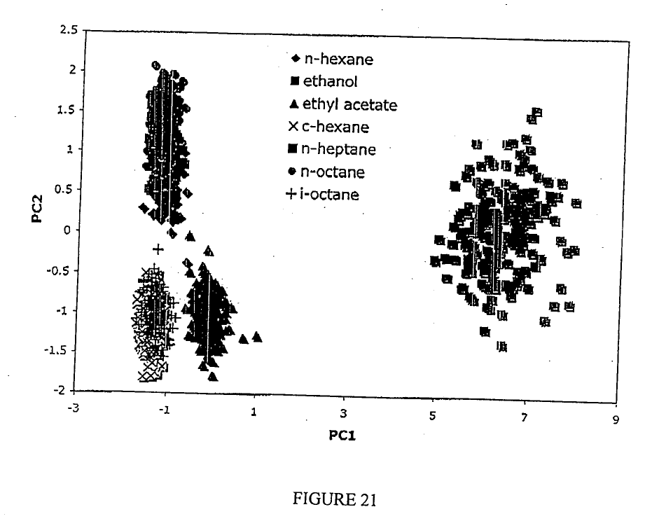

Sensor Array Response To Analytes. Principal components analysis (FIG. 21) was used to visualize the differences in response patterns of a 9 element sensor array (table 10) exposed randomly 200 times to each of the seven analytes at P/P^{o}=0.0050. The points plot in FIG. 21 represent unique response patterns of the sensor array to each of the analytes presented, with the response vectors displayed with respect to the first two principal components of the data set, which contain ˜90% of detector response variance. From the figure, four major clusters are observed: c-hexane and i-octane, n-octane n-heptane and n-hexane, with clusters of ethyl acetate and ethanol observed separately. Even at the relatively low analyte concentrations used in this study, the sensor array readily distinguished between the non-polar and polar analyte vapors.

The classification performance of the sensor array was quantified by use of the Fisher Linear Discriminant algorithm for pairwise analyte classification. The figure of merit to determine the effectiveness of the FLD model is the resolution factor, rf, as defined by eq. 11, which quantifies the measure of separation between two data clusters of interest. The first 100 exposures to each analyte were used as a training set and the remaining 100 exposures to each analyte from the same set of data collection was used as a test set; this train/test scheme was adopted to avoid bias resulting from possible overfitting of data.

Table 15 (a) presents resolution factors for the carbon black-non polymer composite array. For comparison, table 15 (b) presents resolution factors for an array of carbon black-polymer composite sensors consisting of the 9 polymers given in table 12 (b). Non-polymeric sensors appear to operate on the same level of polymeric sensors in terms of resolution factor, in some cases operating at slightly (but significantly) higher resolution factors. Of Note is the improvement in ability to distinguish n-hexane from other analytes. In resolving n-hexane from n-octane, i-octane, and c-hexane, resolution factors increased from 1.65 to 2.61, 3.49 to 5.91, and 2.47 to 6.04, respectively. A resolution factor of 1 implies 68% correct classification, of 2 implies 95.5% correct classification, and of 3 implies 99.7% correct classification, thus these slight improvements at lower levels of resolution translate into large improvements in terms of classification ability.

TABLE 14
Approximate limits of detection of carbon black - non polymer composite
sensors for detection of hexane and ethanol. Limit of detection is defined
as the vapor saturation level at which SNR = 1.

| | concentration | | | | | | | | | |
|---|---|---|---|---|---|---|---|---|---|---|
| analyte | measure | 1 | 2 | 3 | 4 | 5 | 6 | 7 | 8 | 9 |
| Hexane | P/Po | 0.0030 | 0.0020 | 0.0020 | 0.0020 | 0.0015 | 0.0030 | 0.0015 | 0.0020 | 0.0010 |
| | ppm | 526 | 351 | 351 | 351 | 263 | 526 | 263 | 351 | 175 |
| Ethanol | P/Po | 0.0025 | 0.0030 | 0.0035 | 0.0030 | 0.0030 | 0.0020 | 0.0030 | 0.0020 | 0.0020 |
| | ppm | 164 | 197 | 230 | 197 | 197 | 131 | 197 | 131 | 131 |

TABLE 15
(a) Resolution factors displaying the ability of carbon black - non
polymer composite sensors to distinguish between test analytes presented at
P/P^{o} = 0.0050. (b) Resolution factors displaying the ability of carbon black -
polymer composite sensors to distinguish between test analytes presented
at P/P^{o} = 0.0050, from raw data previously reported on (Sisk and Lewis 2005).
In each case, for a given separation task, a Fisher linear discriminant
model was trained on exposures 1-100, and exposures 101-200 were then
tested using the model. Reported values are for exposures 101-200.
(a)

| | | | ethyl | | n- | | i- |
|---|---|---|---|---|---|---|---|
| analyte | n-hexane | ethanol | acetate | c-hexane | heptane | n-octane | octane |
| n-hexane | N/A | 24.67 | 14.13 | 6.04 | 1.25 | 2.61 | 5.91 |
| ethanol | — | N/A | 21.37 | 25.03 | 24.71 | 24.62 | 24.95 |
| ethyl acetate | — | — | N/A | 14.59 | 13.91 | 15.40 | 15.64 |
| c-hexane | — | — | — | N/A | 7.17 | 8.15 | 2.26 |
| n-heptane | — | — | — | — | N/A | 1.27 | 7.88 |
| n-octane | — | — | — | — | — | N/A | 7.68 |
| i-octane | — | — | — | — | — | — | N/A |

(b)

| analyte | hexane | EtOH | EtOAc | c-hex | n-hept | n-oct | i-oct |
|---|---|---|---|---|---|---|---|
| n-hexane | N/A | 10.73 | 6.13 | 2.47 | 1.23 | 1.65 | 3.49 |
| ethanol | — | N/A | 24.20 | 29.10 | 23.28 | 25.23 | 25.85 |
| ethyl acetate | — | — | N/A | 30.42 | 15.51 | 27.09 | 32.09 |
| c-hexane | — | — | — | N/A | 3.94 | 4.43 | 10.23 |
| n-heptane | — | — | — | — | N/A | 1.67 | 6.81 |
| n-octane | — | — | — | — | — | N/A | 6.73 |
| i-octane | — | — | — | — | — | — | N/A |

Stability And Drift. A Fisher model for each binary separation task, consisting of projection weights and a decision boundary, was constructed from sensor responses to the first 100 exposures to each analyte of the first data set. This model was then applied to 700 subsequent exposures, spread over 4 sets of data collection: data set 2 was taken 3 days after data set 1, data set 3 taken 4 days after data set 2, and data set 4 taken 6 months after data set 3. Reported statistics are broken up into these four distinct sets of data collection. Exposures for each binary separation task were projected onto the FLD vector characteristic for the given separation task, placing data into the one-dimensional space which initially maximized the resolution factor between the two analytes of interest.

Analyte projections were compared against the originally modeled decision boundary for the given binary separation, and thus determined to be in one of the two analyte clusters. Table 16 lists performances for all combinations of binary separations for each set of data collection.

TABLE 16
Performance values of carbon black - non polymer composite sensors in
various binary separation tasks.

| | | | | | | | |
|---|---|---|---|---|---|---|---|
| | | | ethyl | | n- | | i- |
| analyte | n-hexane | ethanol | acetate | c-hexane | heptane | n-octane | octane |

day 1 (exposures 101-200)

| | | | | | | | |
|---|---|---|---|---|---|---|---|
| n-hexane | N/A | 1.00 | 1.00 | 1.00 | 0.82 | 0.95 | 1.00 |
| ethanol | — | N/A | 1.00 | 1.00 | 1.00 | 1.00 | 1.00 |
| ethyl acetate | — | — | N/A | 1.00 | 1.00 | 1.00 | 1.00 |
| c-hexane | — | — | — | N/A | 1.00 | 1.00 | 0.92 |
| n-heptane | — | — | — | — | N/A | 0.84 | 1.00 |
| n-octane | — | — | — | — | — | N/A | 1.00 |
| i-octane | — | — | — | — | — | — | N/A |

day 2 (exposures 201-400)

| | | | | | | | |
|---|---|---|---|---|---|---|---|
| n-hexane | N/A | 1.00 | 1.00 | 1.00 | 0.73 | 0.79 | 1.00 |
| ethanol | — | N/A | 1.00 | 1.00 | 1.00 | 1.00 | 1.00 |
| ethyl acetate | — | — | N/A | 1.00 | 1.00 | 1.00 | 1.00 |
| c-hexane | — | — | — | N/A | 1.00 | 1.00 | 0.56 |
| n-heptane | — | — | — | — | N/A | 0.59 | 1.00 |
| n-octane | — | — | — | — | — | N/A | 1.00 |
| i-octane | — | — | — | — | — | — | N/A |

day 3 (exposures 401-600)

| | | | | | | | |
|---|---|---|---|---|---|---|---|
| n-hexane | N/A | 1.00 | 1.00 | 0.99 | 0.66 | 0.79 | 1.00 |
| ethanol | — | N/A | 1.00 | 1.00 | 1.00 | 1.00 | 1.00 |
| ethyl acetate | — | — | N/A | 1.00 | 1.00 | 0.99 | 1.00 |
| c-hexane | — | — | — | N/A | 0.99 | 0.99 | 0.54 |
| n-heptane | — | — | — | — | N/A | 0.64 | 1.00 |
| n-octane | — | — | — | — | — | N/A | 1.00 |
| i-octane | — | — | — | — | — | — | N/A |

day 4 (exposures 601-800)

| | | | | | | | |
|---|---|---|---|---|---|---|---|
| n-hexane | N/A | 0.94 | 0.98 | 0.51 | 0.51 | 0.50 | 0.59 |
| ethanol | — | N/A | 1.00 | 0.88 | 0.95 | 0.91 | 0.98 |
| ethyl acetate | — | — | N/A | 0.99 | 0.98 | 0.99 | 0.90 |
| c-hexane | — | — | — | N/A | 0.52 | 0.51 | 0.50 |
| n-heptane | — | — | — | — | N/A | 0.50 | 0.59 |
| n-octane | — | — | — | — | — | N/A | 0.62 |
| i-octane | — | — | — | — | — | — | N/A |

Binary separation performances were comparable throughout the first 3 data sets. However, the fourth data set performed extremely poor in many situations. In terms of the Fisher model, two possible explanations of this performance loss are: 1) a new dimension for each binary analyte separation captures maximum resolution between analyte clusters, and a new model needs to be created with different projection weights for each analyte and a new decision boundary created; or, 2) the same model approximately captures maximum resolution between analyte clusters, but clusters have drifted with respect to the original decision boundary. Regarding the latter case, a calibration scheme has proven capable of restoring performance for carbon black-polymeric composite sensors. This calibration scheme adjusts sensor responses by a multiplicative calibration factor observed by the sensor array in transitioning from previous exposures (train phase) to current exposures (test phase) for a chosen calibration analyte, and is given by:

$${S}_{a , t} = {S}_{c , t} \frac{{S}_{a , 0}}{{S}_{c , 0}} \qquad ( 13 )$$

S_{a,t} and S_{c,t} indicate the ΔR/Rb response signals for an analyte a or calibrant c, respectively, some time t after training.

Table 17 gives performances for each combination of binary separation, using each analyte as a calibrant, when the initial model (based on exposures 1-100, data set 1) is used on the final data set (200 exposures, recorded 6 months after initial data set). The first three exposures from the final data set were used to calibrate the model according to equation (5), followed by 47 test exposures. This cycle of calibrate/test was repeated 3 additional times, consuming all 200 exposures of the final data set. For clarity, performances are given for binary separations both without the use of calibration and for the calibrant that proved most effective; cases where reasonable performances are attained are shown in bold text. Of the 21 combinations of binary analyte separations, 17 yield reasonable results, with approximately 90% or better performance scores.

TABLE 17
Performance values of carbon black - non polymer composite sensors when a
Fisher linear discriminant model is trained on 100 exposures and test on
200 exposures 6 months later, with the use of calibration. Scenarios for
the best calibrant and the use of no calibrant are listed for direct
comparison; highlighted are binary separation tasks capable of high
performances with a 6 month period between the train and test phase.

| | | | | | | | | Calibrant | |
|---|---|---|---|---|---|---|---|---|---|
| | Calibrant Used | | | | | | | Comparison | |
| | n- | | ethyl | c- | n- | n- | i- | no | best |
| classification task | hexane | ethanol | acetate | hexane | heptane | octane | octane | calibrant | calibrant |
| n-hexane/ethanol | 0.58 | 0.98 | 1.00 | 0.82 | 0.86 | 0.96 | 0.95 | 0.94 | 1.00 |
| n-hexane/ethyl acetate | 0.57 | 0.96 | 0.98 | 0.70 | 0.85 | 0.73 | 0.84 | 0.98 | 0.98 |
| n-hexane/c-hexane | 0.86 | 0.52 | 0.51 | 0.83 | 0.88 | 0.90 | 0.74 | 0.51 | 0.90 |
| n-hexane/n-heptane | 0.50 | 0.56 | 0.55 | 0.50 | 0.53 | 0.50 | 0.49 | 0.51 | 0.56 |
| n-hexane/n-octane | 0.49 | 0.57 | 0.56 | 0.51 | 0.53 | 0.55 | 0.51 | 0.5 | 0.57 |
| n-hexane/i-octane | 0.91 | 0.59 | 0.60 | 0.88 | 0.95 | 0.97 | 0.86 | 0.59 | 0.97 |
| ethanol/ethyl acetate | 0.51 | 1.00 | 1.00 | 0.75 | 0.84 | 0.86 | 0.76 | 1 | 1.00 |
| ethanol/c-hexane | 0.58 | 0.95 | 0.99 | 0.83 | 0.85 | 0.98 | 0.95 | 0.88 | 0.99 |
| ethanol/n-heptane | 0.59 | 0.90 | 0.99 | 0.83 | 0.86 | 0.98 | 0.97 | 0.95 | 0.99 |
| ethanol/n-octane | 0.57 | 0.89 | 0.99 | 0.84 | 0.85 | 0.97 | 0.96 | 0.91 | 0.99 |
| ethanol/i-octane | 0.57 | 0.99 | 1.00 | 0.85 | 0.86 | 0.99 | 0.98 | 0.98 | 1.00 |
| ethyl acetate/c-hexane | 0.57 | 0.86 | 0.98 | 0.73 | 0.84 | 0.73 | 0.83 | 0.99 | 0.98 |
| ethyl acetate/n-heptane | 0.58 | 0.76 | 0.97 | 0.71 | 0.85 | 0.74 | 0.85 | 0.98 | 0.97 |
| ethyl acetate/n-octane | 0.57 | 0.97 | 0.99 | 0.72 | 0.85 | 0.74 | 0.85 | 0.99 | 0.99 |
| ethyl acetate/i-octane | 0.53 | 0.53 | 0.89 | 0.72 | 0.81 | 0.72 | 0.82 | 0.9 | 0.89 |
| c-hexane/n-heptane | 0.86 | 0.70 | 0.68 | 0.82 | 0.86 | 0.91 | 0.78 | 0.52 | 0.91 |
| c-hexane/n-octane | 0.90 | 0.91 | 0.79 | 0.82 | 0.91 | 0.95 | 0.83 | 0.51 | 0.95 |
| c-hexane/i-octane | 0.48 | 0.50 | 0.50 | 0.58 | 0.48 | 0.54 | 0.57 | 0.5 | 0.58 |
| n-heptane/n-octane | 0.49 | 0.52 | 0.51 | 0.50 | 0.51 | 0.54 | 0.51 | 0.5 | 0.54 |
| n-heptane/i-octane | 0.89 | 0.89 | 0.80 | 0.88 | 0.93 | 0.97 | 0.90 | 0.59 | 0.97 |
| n-octane/i-octane | 0.89 | 0.90 | 0.88 | 0.87 | 0.91 | 0.96 | 0.91 | 0.62 | 0.96 |

For binary separations reporting unacceptable performances, the sensor array is still capable of resolving between analyte pairs, although a train period is again required, as done initially. For example, the binary classification of hexane and n-heptane reports a performance of 0.49 and has a resolution factor of 0.02 when the initial model is applied to the final data set. If the first 100 exposures of data set 4 are used to train a new model, a resolution factor of 1.5 and performance of 0.88 is achieved when testing the model against the final 100 exposures of data set 4. These are comparable to values resulting from training on the first 100 exposures and testing on the final 100 exposures of data set 1, with a resolution factor and performance of 1.5 and 0.88, respectively (tables 15 and 16). No sensor performance has been lost, but the model describing sensor behavior has changed too much for calibration to be useful.

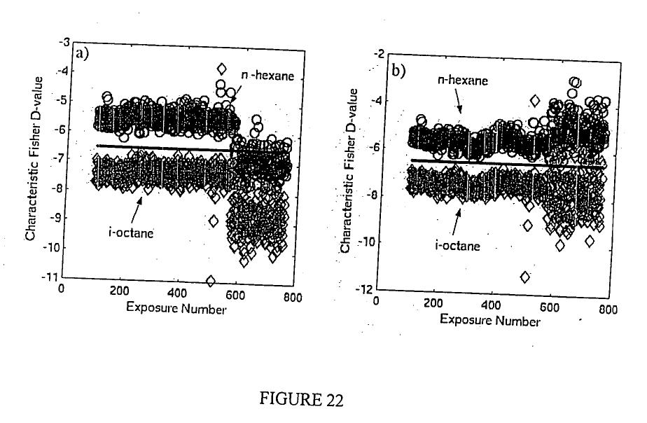

FIG. 22 details what happens during drift, and how calibration corrects for it. FIG. 22 (a) shows projections of 700 exposures, spread over 4 sets of data collection, for a Fisher model based on the first 100 exposures of data set 1. FIG. 22 (b) shows these same projections, but when a calibration scheme is adopted where 3 exposures are fist used as calibrant runs, followed by 47 test exposures; this is repeated through the remaining 700 exposures. It is easily observed that this projected dimension maintains a reasonable level of separation between the two analytes, however the analyte clusters have drifted relative to the decision boundary. The calibration employed shifts these projections back on track relative to the decision boundary, and classification is again achievable.

The properties of the carbon black-non-polymeric organic phase composite sensors and sensor arrays compare favorably in many respects to those of the well-investigated carbon black-polymer composite sensing films.

The ability of a sensor array is ultimately measured by the resolution factor, for which the non-polymeric sensors appear to be at least on par with those of polymeric sensors (table 14), and in some cases showing slight improvement in critical regions where even the smallest increase in resolution factor yields significant improvements with respect to classification ability. For the sensors to have performed as well as have been reported in terms of resolution factor, even with the much weaker SNR, is a feat of merit. The sensors described thus represent a complimentary pathway to polymer-based systems in formulating effective sorption phases for chemiresistive composite-based vapor sensing applications.

Long-term drift studies provided excellent results. Using performance as the measure of choice, when the sensors were used 6 months after an initial train period, 11 of the 21 binary separation tasks provided satisfactory results, with correct classification on approximately 90% or greater of those attempted (table 15, 16). When a simple calibration scheme was employed (equation 13), requiring only 3 calibration exposures per 50, the number of satisfactory binary separations increased to 17, leaving only 4 separation tasks rendered incapable by the original model. Polymer-based sensors have been shown to be subject to this drift, and the calibration scheme has proven useful in most cases of binary separation. Those cases where performance was unacceptable even after calibration are the same as those reported here, for example n-hexane/n-heptane and n-heptane and n-octane (Sisk and Lewis 2005). For most binary separation tasks, non-polymeric sensors provide adequate performance levels for at least 6 months after an initial train phase.

Plasticizers such as dioctyl phthalate (a viscous liquid) have been added to polymers to lower their glass transition temperature and decrease the sensor response time to various vapors. The sensors studied herein showed response times that were rapid in the absence of dioctyl phthalate or similar plasticizers. Note the difference in time required for an equilibrium response between a non-polymer and polymeric composite sensor (FIG. 17). This rapid time response is characteristic of the use of low molecular weight monomeric organic molecules as the sorbent phase.

The ratio of the ΔR/Rb responses of sensors 6 and 2 (table 1) to ethanol and hexane (polar and nonpolar) was 20 and 0.1, respectively. Such large differences for various other analytes could be found by further development of this class of sensors. This class of sensors has a great multitude of options, as they are not limited to being polymer-based, and as such finding sensors to target certain analytes should be more realizable than for other sensor types

The use of monomeric organic compounds as the sorption material in chemiresistors allows the production of a new class of chemical sensors.

### CITED REFERENCES

1. Lundstrom et al. (1991) Nature 352:47-50;
2. Shurmer and Gardner (1992) Sens. Act. B 8:1-11;
3. Reed (1992) Neuron 8:205-209;
4. Lancet and Ben-Airie (1993) Curr. Biol. 3:668-674;
5. Kauer (1991) TINS 14:79-85;
6. DeVries and Baylor (1993) Cell 10(S):139-149;
7. Gardner et al. (1991) Sens. Act. B 4:117-121;
8. Gardner et al. (1991) Sens. Act. B 6:71-75;
9. Corcoran et al. (1993) Sens. Act. B 15:32-37;
10. Grate and Abraham (1991) Sens. Act. B 3:85-111;
11. Grate et al. (1993) Anal. Chem. 65:1868-1881;
12. Stetter et al. (1986) Anal. Chem. 58:860-866;
13. Stetter et al. (1990) Sens. Act. B 1:4347;
14. Stetter et al. (1993) Anal. Chem. Acta 284:1-11;
15. Pearce et al. (1993) Analyst 118 371-377;
16. Shurmer et al. (1991) Sens. Act. B 4:29-33;
17. Topart and Josowicz (1992) J. Phys. Chem. 96:7824-7830;
18. Charlesworth et al. (1993) J. Phys. Chem. 97:5418-5423;
19. Hecht (1990) Mathetnnics in Chemistry: An Introduction to Modern Methods (Prentice Hall, Englewood Cliffs, N.J.);
20. Pope (1983) Heteropoly and Isopoly Oxometalates (Springer-Verlag, N.Y.), chap. 4;
21. Salmon et al. (1982) J. Polym. Sci., Polym. Lett. 20:187-193;
22. Andrieux et al. (1990) J. Am. Chem. Soc. 112:2439-2440;
23. Diaz et al. (1981) J. Electroanal. Chem. 121:355-361;
24. Kanazawa et al. (1981) Synth. Met. 4:119-130;
25. Bidan et al. (1988) J. Electroanal. Chem. 251:297-306;
26. Kaufman et al. (1984) Phys. Rev. Lett. 53:1005-1008;
27. Yakushi et al. (1983) J. Chem. Phys. 79:4774-4778; and
28. Morris et al. (1942) Can. J. Res. B 20:207-211.

All publications and patent applications cited in this specification are herein incorporated by reference as if each individual publication or patent application were specifically and individually indicated to be incorporated by reference. Although the foregoing disclosure has been described in some detail by way of illustration and example for purposes of clarity of understanding, it will be readily apparent to those of ordinary skill in the art in light of the teachings of this disclosure that certain changes and modifications may be made thereto without departing from the spirit or scope of the appended claims.

What is claimed is:

1. A sensor for detecting an analyte in a fluid comprising a sensing area between at least two conductive leads, the sensing area comprising a region of a non-conductive material and a region of a conductive material, wherein the non-conductive material is an inorganic material, a non-organic material, a non-polymeric organic material, or combinations thereof, wherein the sensing area provides an electrical path through said regions of non-conductive material and conductive material and wherein the sensing area is in contact with an analyte to be detected.

2. The sensor according to claim 1, wherein the conductive material is carbon black.

3. The sensor according to claim 2, wherein the non-conductive material is an inorganic non-conductive material.

4. The sensor according to claim 2, wherein the non-conductive material is a non-polymeric non-conductive material.

5. The sensor according to claim 2, wherein the non-conductive material comprises a non-conductive capped colloid particle.

6. The sensor according to claim 1, wherein the conductive material is an inorganic conductor.

7. The sensor according to claim 1, wherein the conductive material is a conductive polymeric material and the non-conductive material is an inorganic material.

8. The sensor according to claim 1, wherein the sensor comprises a plurality of alternating non-conductive regions and conductive regions.

9. The sensor according to claim 7, wherein the inorganic non-conductive material is a mixed inorganic/organic material comprising an insulating capped colloid particle.

10. The sensor according to claim 9, wherein the insulating capped colloid particle is an alkylthiol-capped gold particle or a capped TiO₂ particle.

11. The sensor according to claim 7, wherein the inorganic material is selected from the group consisting of BeO, a ceramic, a glass, a mica, LiF, Li₂O, A₂O₃, BaF₂, CaF₂, MgF₂, silicon carbide, Al—Mg, a boron-doped oxide, a phosphorus-doped oxide, a boron and phosphorus-doped oxide, and a fluorine-doped oxide.

12. The sensor according to claim 11, wherein the ceramic is selected from the group consisting of alumina (Al₂O₃), silica (SiO₂), zirconia (ZrO), magnesia, mullite, cordierite, aluminum silicate, forsterite, petalite, eucryptite and quartz glass, SiOₓ, SiN, SiNₓ, SiON, TEOS, and Si₃N₄.

13. The sensor according to claim 1, wherein the non-conductive material is a non-polymeric material.

14. The sensor according to claim 13, wherein the non-polymeric material is selected from the group consisting of tris (hydroxymethyl) nitromethane, tetrapctulammonium bromide, lauric acid, tetrocosane acid, 3-methyl-2-pherylvaleric acid, eicosane, tetracosane, triactane, propyl gallate, 1,2,5,6,9,10-hexabromocyclododecane, quinacrine dihydrochloride dihydrate, dioctyl phthalate, and any combination thereof.

15. The sensor according to claim 13, wherein the conductive material is selected from the group consisting of an inorganic conductor, an organic conductor, and a mixed inorganic-organic conductor.

16. A sensor array for detecting an analyte in a fluid comprising a plurality of sensors wherein at least one sensor comprises a sensor of claim 1.

17. A system for detecting an analyte in a fluid, said system comprising:
a sensor array of claim 16;
an electrical measuring device electrically connected to the sensor array; and
a computer comprising a resident algorithm;
wherein the electrical measuring device detecting an electrical resistances in each of said sensors and the computer assembling the resistances into a sensor array response profile.

18. A method for detecting the presence of an analyte in a fluid, said method comprising:
resistively sensing the presence of an analyte in a fluid with a sensor array according to claim 16.

19. A method of manufacturing a chemically sensitive sensor, comprising:
providing a non-conductive material and a conductive material, a solvent, at least two conductive leads and a substrate;
contacting the substrate with a mixture comprising the conductive material, the non-conductive material, or a combination thereof such that the mixture is contacted with the substrate between the at least two conductive leads; and
allowing the solvent to substantially evaporate leaving a sensor film between the two conductive leads,
wherein the non-conductive material is an inorganic non-conductive material, a non-organic non-conductive material, or a non-polymeric non-conductive material.

20. The method of claim 19, wherein the mixture is generated by mechanical mixing.

21. The method of claim 20, wherein the mechanical mixing includes ball-milling.

22. The method of claim 20, wherein the mechanical mixing further comprises heating.

23. The method of claim 19, wherein the non-conductive material and the conductive material are soluble in the solvent, and wherein the step of mixing includes dissolving.

24. The method of claim 29, wherein at least one of the materials is insoluble in the solvent, and wherein the mixture is made by:
dissolving the soluble material(s) in the solvent to form a solution; and
suspending the insoluble material(s) in the solution to form a suspension.

25. The method of claim 24, wherein the step of suspending the insoluble material in the solution includes vigorous mixing.

26. The method of claim 24, wherein the step of suspending the insoluble material in the solution further comprises sonication.

27. The method of claim 24, wherein the solvent is a polar solvent.

28. The method of claim 27, wherein the polar solvent is selected from the group consisting of tetrahydrofuran, acetonitrile and water.

29. The method of claim 24, wherein the solvent is a nonpolar solvent.

30. The method of claim 19, wherein the step of contacting is selected from the group consisting of spinning, spraying and dip coating.

31. The method of claim 19, wherein the substrate is a non-conductive substrate.

32. The method of claim 31, wherein the non-conductive substrate is selected from the group consisting of glass, ceramic, and printed circuit board material.

33. The method of claim 19, wherein the substrate is a semiconductive substrate.

34. The method of claim 33, wherein the semiconductive substrate is selected from the group consisting of Si, GaAs, InP, MoS₂, and TiO₂.

35. The method of claim 19, wherein the substrate is an integrated circuit.

36. The method of claim 19, wherein the conductive material is selected from the group consisting of organic conductors, inorganic conductors and mixed inorganic/organic conductors.

37. The method of claim 19, wherein after the step of allowing the solvent to substantially evaporate, the method further comprises the step of removing the sensor film from the substrate.

38. The method of claim 19, wherein the non-conductive material is an inorganic non-conductive material.

39. The method of claim 38, wherein the inorganic non-conductive material is a mixed inorganic/organic material comprising an insulating capped colloid particle.

40. The method of claim 39, wherein the insulating capped colloid particle is an alkylthiol-capped gold particle or a capped TiO₂ particle.

41. The method of claim 19, wherein the inorganic material is selected from the group consisting of BeO, a ceramic, a glass, a mica, LiF, Li₂O, A₂O₃, BaF₂, CaF2, MgF₂, silicon carbide, Al—Mg, a boron-doped oxide, a phosphorus-doped oxide, a boron and phosphorus-doped oxide, and a Fluorine-doped oxide.

42. A method of manufacturing a chemically sensitive sensor, comprising:
providing a solution of a non-conductive material and a solution of a conductive material, a substrate having a pre-selected region between at least two conductive leads and an inkjet device, wherein the non-conductive material is an inorganic non-conductive material, a non-organic non-conductive material, and/or a non-polymeric non-conductive material;
delivering at least one solution to the inkjet device; and
ejecting the at least one solution from the inkjet device onto the pre-selected region of the substrate.

43. A sensor array for detecting an analyte in a fluid, comprising:
at least first and second chemically sensitive resistors electrically connected to an electrical measuring apparatus, each of said chemically sensitive resistors comprising:
regions of a non-conductive material and a conductive material, wherein the non-conductive material is an inorganic non-conductive material, a non-organic non-conductive material, and/or a non-polymeric non-conductive material, wherein each resistor provides an electrical path through said regions of non-conductive material and said regions of conductive material,
a first electrical resistance when contacted with a first fluid comprising a chemical analyte at a first concentration, and
a second electrical resistance when contacted with a second fluid comprising said chemical analyte at a second different concentration,
wherein the difference between the first electrical resistance and the second electrical resistance of said first chemically sensitive resistor being different from the difference between the first electrical resistance and the second electrical resistance of said second chemically sensitive resistor under the same conditions.
